(19) United States
(12) Patent Application Publication
(10) Pub. No.: US 2025/0267010 A1
(43) Pub. Date: Aug. 21, 2025

(54) Systems and Methods for Authentication and Verification of Data

(71) Applicant: PIT Labs Inc., New York, NY (US)

(72) Inventors: Grigori Kapoustin, San Mateo, CA (US); Daniel Averbukh, New York, NY (US); Manuel Mueller-Frank, Madrid (ES)

(21) Appl. No.: 19/059,001

(22) Filed: Feb. 20, 2025

Related U.S. Application Data
(60) Provisional application No. 63/555,873, filed on Feb. 20, 2024.

(51) Int. Cl. H04L 9/32; H04L 9/00

(52) U.S. Cl. CPC H04L 9/3247; H04L 9/50

(57) ABSTRACT

A method for providing authenticatable data is described. The method is performed at a first device with one or more processors and memory storing instructions for execution by the one or more processors. The method includes generating a commitment string associated with a digital object; generating a signed commitment request based on the commitment string and a private key associated with the first device; and sending the signed commitment request and data indicative of an identity of the first device to a second device that is distinct from the first device. The commitment string includes a content identifier for the digital object. The signed commitment request includes the commitment string and a cryptographic signature for the commitment string.

### RELATED APPLICATIONS

This application claims the benefit of, and priority to, U.S. Provisional Patent Application Ser. No. 63/555,873, filed Feb. 20, 2024, which is incorporated by reference herein in its entirety.

### TECHNICAL FIELD

This relates generally to systems, methods, and devices for the authentication and verification of digital data.

### BACKGROUND

Verifying from one computer system that data generated by another computer system is a complete and authentic original record (e.g., has not been modified, tampered with, compromised, etc.) is challenging. Furthermore, it is difficult to verify from one computer system that the properties of data generated by another computer system (e.g., time of generation, file size, associated metadata, labels, etc.) are accurate and preserved in an unmodified form so that this data can be used reliably for data processing purposes (e.g., validation, authentication, data analytics, mathematical calculations, cryptographic transactions, etc.).

It is also difficult to verify from one computer system that data processing performed by another computer system was performed in accordance with a predefined set of rules, set of permissions (e.g., with authentication protocols, secure cryptographic processing, etc.), and/or based on validated data. The difficulties increase when an end user needs to verify the authenticity of data received from multiple input datasets, respectively generated by multiple systems or devices, some of which may be operated in untrusted environments or by competitive entities, or may be readily available for intentional or unintentional modifications.

In some systems, a centralized computer system may store records and/or labels associated with digital data and refer to these later for verification purposes. Such a centralized verification solution may not be appropriate in some applications due to the reliance on the centralized computer system. Such reliance may create unacceptably high risks for users of the centralized verification system. Some users may be unable to rely on a centralized verification system for vital data processing services due to potential conflicts of interest and/or lack of trust. Furthermore, reliance on centralized infrastructure for critical services may create security vulnerabilities and endanger reliability to an extent unacceptable in some high-value applications.

Strict access control mechanisms (e.g., data access restricted to authorized users or processes) to ensure the integrity and authenticity of data stored in a centralized verification system can be expensive, cumbersome, and impractical. Other protective measures can involve authentication protocols, authorization checks, and audit trails that record data access and data modification attempts. These measures are prone to internal or external security breaches.

Systems relying on distributed databases and/or ledgers can be inefficient, time-consuming, impractical, and costly to implement in existing enterprise software environments. For example, accessing blockchains typically requires specialized interfaces, network nodes, and cryptocurrency to access and fund network transactions. Additionally, processing and validating data across distributed databases risks disclosure of sensitive private information.

### SUMMARY

As such, there remains a need to provide robust, low-cost, secure, and verifiable digital data records across various applications. Systems and methods described herein enable storage, management, and processing of digital data and their commitments in a tamper-resistant manner without running the risk of disclosing private data over publicly accessible distributed ledgers. Such systems and methods are free from the control issues and security vulnerabilities associated with a centralized verification system.

Systems, methods, and devices described herein use cryptographic protocols and associated data processing to manage and authenticate digital data stored across distributed databases (e.g., distributed ledger systems) for providing secure, efficient, and low-cost authentication services.

As described herein, data management and authentication systems based on a combination of distributed and/or specialized databases provide efficient, user-friendly, secure, and cost-effective validation of sensitive data while keeping the confidentiality of the sensitive data (e.g., without disclosing the sensitive data).

The above-discussed deficiencies and other problems associated with conventional data management and authentication protocols are reduced or eliminated by the disclosed systems and methods for the management and validation of digital data, and its corresponding commitments, over a distributed database.

The systems and methods for providing verifiable data for a distributed database may be integrated with, or interact with, one or more of: digital object producer devices (e.g., devices that create digitally stored and managed data), content identifier generator devices (e.g., devices that transform the digital data to preserve privacy, such as by calculating a hash function of the digital objects), commitment maker devices (e.g., devices that process transactional data with binding labels, metadata, and other property information that is of interest to an end-user), commitment service provider devices (e.g., devices that offer services for storing and managing binding commitments made by commitment makers), prover devices (e.g., an entity for asserting the truthfulness of a statement and providing evidentiary support), or verifier devices (e.g., an entity that evaluates and validates the evidence or proof).

In accordance with some embodiments, a method for providing authenticatable data includes operations performed at a first device with one or more processors and memory storing instructions for execution by the one or more processors. The method includes receiving a message to submit a signed commitment request for a digital object; and, in response to receiving the message to submit the signed commitment request for the digital object: obtaining a content identifier for the digital object; generating a commitment string associated with the digital object. The commitment string includes a content identifier for the digital object. The method also includes generating the signed commitment request based on the commitment string and a private key associated with the first device. The signed commitment request comprises the commitment string and a cryptographic signature for the commitment string. The method further includes, subsequent to generating the signed commitment request, sending, to a second device that is distinct from the first device, the signed commitment request and data indicative of an identity of the first device.

In accordance with some embodiments, a method for providing authenticatable data includes operations performed at a first device with one or more processors and memory storing instructions for execution by the one or more processors. The method includes obtaining a content identifier for the digital object; generating a commitment string associated with the digital object. The commitment string includes a content identifier for the digital object. The method also includes generating the signed commitment request based on the commitment string and a private key associated with the first device. The signed commitment request comprises the commitment string and a cryptographic signature for the commitment string. The method further includes, subsequent to generating the signed commitment request, sending, to a second device that is distinct from the first device, the signed commitment request and data indicative of an identity of the first device.

In accordance with some embodiments, a method for providing authenticatable data includes, at a first electronic device with one or more processors and memory storing instructions for execution by the one or more processors, generating a forward request based on a signed commitment request. The forward request includes a signed commitment request and data indicative of an identity of a second electronic device that is distinct from the first electronic device. The signed commitment request is generated based on a commitment string associated with a digital object and a private key associated with the second electronic device. The commitment string includes a content identifier for the digital object. The signed commitment request comprises the commitment string and a cryptographic signature for the commitment string. The method also includes, subsequent to generating the forward request, sending, to a third device, the forward request and data indicative of an identity of the second device.

In accordance with some embodiments, an electronic device includes one or more processors and memory storing one or more programs for execution by the one or more processors. The one or more programs include instructions, which, when executed by the one or more processors, cause the one or more processors to perform any method described herein.

In accordance with some embodiments, a computer readable storage medium stores one or more programs for execution by one or more processors. The one or more programs include instructions, which, when executed by the one or more processors, cause the one or more processors to perform any method described herein.

Thus, the disclosed embodiments provide efficient, secure, and cost-effective management and authentication of digital objects and results of processing such digital objects.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a high-level architecture in accordance with some embodiments.

FIG. 2 is a block diagram of an application programming interface (API) service device and a commitment service device in accordance with some embodiments.

FIG. 3 illustrates a method for providing authenticatable data in accordance with some embodiments.

FIG. 4 illustrates a method for providing authenticatable data in accordance with some embodiments.

FIG. 5 illustrates a method for providing authenticatable data in accordance with some embodiments.

FIG. 6 illustrates a method for verifying authenticatable data in accordance with some embodiments.

FIG. 7 illustrates a method for verifying authenticatable data in accordance with some embodiments.

FIG. 8 illustrates an electronic device in accordance with some embodiments.

These figures are not drawn to scale unless indicated otherwise.

### DETAILED DESCRIPTION

There is a need for a computer system that can provide validation of digital objects over a network without disclosing the underlying data. The computer system, even when implemented to utilize a distributed database system, can overcome the challenges associated with inefficient and time-consuming use of distributed databases.

The present disclosure describes methods and systems that allow validation of digital objects, and processes associated with such digital objects without publicly disclosing the digital objects or the data contained in such digital objects.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to obscure other aspects of the embodiments.

It will also be understood that, although the terms first, second, etc. are, in some instances, used herein to describe various elements, these elements should not be limited by these terms. These terms are used only to distinguish one element from another. For example, a first device could be termed a second device, and, similarly, a second device could be termed a first device, without departing from the scope of the various described embodiments. The first device and the second device are both user devices, but they may not be the same device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “exemplary” is used herein in the sense of “serving as an example, instance, or illustration” and not in the sense of “representing the best of its kind.”

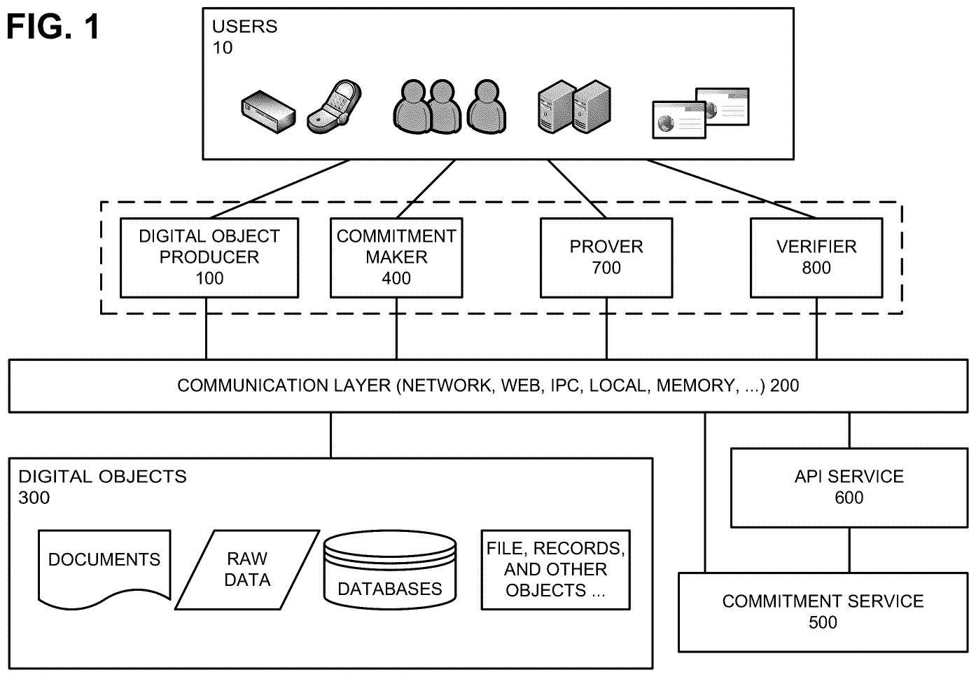

FIG. 1 shows a high-level architecture of the system showing users 10, digital object producer device 100, commitment maker device 400, prover device 700, verifier device 800, communication layer 200, application programming interface (API) service device 600, commitment service device 500, and digital objects 300.

A digital object producer device 100 can create one or more digital objects 300. Examples of digital objects 300 include but are not limited to, files on a local file system, files on a network or cloud file system, objects in a cloud storage environment, databases, records in a database, documents, possibly in a document storage service or database, contents of one or more other digital objects, software or computer instructions in a high-level code or language or a low-level machine code, and raw data present in computer memory. Generally, a digital object is a digital entity (e.g., a computer file) capable of holding data, typically with some structure to facilitate its processing, analysis, and interpretation. Digital objects are often characterized by their ability to be stored, transmitted, or processed in a digital form. A digital object can contain other digital objects. A file is a specific type of digital object that stores data in a structured format. It is a common unit of storage in computers and digital systems, typically part of a file system and identified by a filename. A file is typically a container for one or more other digital objects.

Digital objects 300 may form structures (e.g., may be assembled into sets) and may contain or be associated with metadata that can facilitate specific applications. For example, a first set is a collection of one or more digital objects 300 associated with the same metadata for a first label and a second set is a collection of one or more digital objects associated with the same metadata for a second label. In some instances, metadata can be, or include, structured information that describes, explains, locates, or otherwise makes it easier to use or manage the digital objects 300. For example, metadata can be descriptive information (labels providing identifying information about the data, etc.), structural information, administrative information, and related provenance information. For example, in some embodiments, digital objects 300 contain metadata comprising credential information represented as a credential document, database record, dictionary, or collection of key-value pairs containing the credential data. In some embodiments, digital objects 300 contain financial information or invoice information and may be represented as a corresponding document, database record, dictionary, or collection of key-value pairs containing the financial data or invoice data. In some embodiments, digital objects 300 contain digital media, such as images and video. In some embodiments, digital objects 300 contain information derived from devices or sensors. In some embodiments, digital objects 300 contain digital communication data, including but not limited to emails, messages, recordings, and transcripts.

In some embodiments, digital objects 300 contain information along with a signature of the entity that created the digital object or produced the information contained in the digital object. In some implementations, digital objects 300 contain a photo along with a signature of the digital camera or the hardware module of the digital camera that provides cryptographic signatures. In some embodiments, a cryptographic signature, or digital signature, is used as a mathematical scheme for demonstrating the authenticity and integrity of a digital message or document. A valid cryptographic signature gives a recipient reason to believe that the message was created by a known sender (authentication) and that the message was not altered in transit (integrity). The signature binds, or associates, the signer to the message, making it difficult for the signer to deny having signed the message (non-repudiation). Cryptographic signatures typically use a pair of keys: a private key and a public key. The private key, which is kept secret by its owner, is used to create the signature. The corresponding public key, which can be shared with others, is used to verify the signature.

Signing a message involves creating a unique signature that is based on the content of the message and the signer's private key. This signature is attached to the message. The recipient of the message uses the sender's public key to verify the signature. The public key is related to the private key but cannot be used to derive the private key.

In some implementations, digital objects 300 contain a device output or sensor reading along with a signature of the digital device that produced it or the hardware module of the digital device that provides cryptographic signatures. In some implementations, digital objects 300 contain experimental data, including but not limited to device output, sensor measurements, and data collected or reported by humans. Assigning experiment-specific set identifiers to the commitments associated with particular experiments allows anyone with whom results are shared in the future to determine whether they are receiving a complete record of all digital objects pertaining to the experiment. In some cases, an experiment could be a drug trial for which a commitment is made for each participant in the trial using an experiment-specific set. The set identifier associated with this experiment makes it transparent and quickly verifiable how many patients started the trial so that the trial outcome can be traced for each patient and the possibility of survivorship bias or cherry-picking results eliminated. These commitments for each patient using the trial set make it impossible to drop patients from the trial silently.

In some embodiments, a hospital creates an object commitment corresponding to each change in patient medical records using a set corresponding to the patient. These set commitments corresponding to all patient's medical record commitments allow anyone analyzing these medical records to verify that they are analyzing a complete set of the hospital's records for the given patient. In case of any subsequent disputes about care, the completeness of the records can be proven, and accusations of data tampering during the disagreement can be proven or disproven with certainty.

In some embodiments, digital objects 300 contain the results of calculations including, but not limited to, the output of models, functions, predictive analytics applications, and artificial intelligence systems. In some embodiments, digital objects 300 contain the inputs and the outputs of such models and functions.

A digital object may have multiple equivalent representations. For example, a credential may be represented as a set of key-value pairs or the rendering of this key-value information using a specific document template in the PDF document format.

The digital object producer device 100 may be a stand-alone entity or a system (e.g., device, users 10, or a service) performing operations initiated by another entity, either directly and/or via intermediaries. In some embodiments, the digital object producer device 100 may use a communication layer 200 to create digital objects 300 and access these digital objects. In some embodiments, the digital object producer device 100 may access digital objects 300 directly, for instance, on a local file system or via additional services and intermediaries, for instance, cloud services and APIs, such as bucket storage and database services. Depending on the implementation details and the infrastructure used, management of the digital objects 300 may be provided by an operating system or a network service.

In some embodiments, the digital object producer device 100 cryptographically signs the digital object produced. For example, a digital camera, device, sensor or hardware module can be a digital object producer and cryptographically sign the data respectively generated.

In some embodiments, the digital object producer device 100 appends multiple signatures to the digital object produced. For example, if the digital object encodes a commercial transaction among multiple parties, the digital object producer device 100 obtains signatures from the parties engaging in the transaction.

Upon the creation of the digital object 300 or upon performing actions on the digital objects 300 (e.g., cryptographically signing the digital object), the digital object producer device 100 uses the communication layer 200 to communicate with other components. In some embodiments, the digital object producer device 100 communicates to the commitment maker device 400 that the state of the digital objects 300 has changed.

Components of the system, such as the digital object producer device 100 and the commitment maker device 400, interact using the communication layer 200. Depending on the implementation and the specific scenario, the communication layer 200 can be local communication within a computer using local memory within a process or inter-process communication (IPC). The communication layer 200 can also involve communication among computers on a local network or over the internet, including HTTP traffic over the Web.

In some embodiments, some or all components are implemented as different services running on different computers and accessible over communication networks. In some embodiments, some or all components are implemented within a single physical computer or within a single process running within a single physical computer. For example, the digital object producer device 100 and the commitment maker device 400 may share a process executing on a given computer, whereas the commitment service device 500 may be accessed over the Web using HTTP.

In some embodiments, the commitment maker device 400 communicates with a commitment service device 500 to create one or more commitment records C related to one or more digital objects 300. In some embodiments, the commitment maker device 400 accesses digital objects 300, or receives their copies, or receives other information required to generate one or more commitment records C subsequent to digital object creation, possibly after a delay. The information (e.g., digital objects 300, rules, permissions, etc.) required to make the commitment record C may be communicated using automated or non-automated methods. As discussed above, the commitment maker device 400 may be a component of the same program or computer as the digital object producer device 100.

In some embodiments, the commitment record is, or includes, a commitment string of numbers and/or characters encoding a digital object of the one or more digital objects 300 generated by the commitment maker device 400. For example, a commitment record C can include one or more values (e.g., mathematical functions) to be stored, a cryptographic signature of the party making the commitment, and meta-data, such as the timestamp of the commitment. As another example, the commitment record C can include a digital object's properties, relationships with other objects, and/or data related to the identity of the digital object producer device 100. In some embodiments, the commitment record is a state transition in the commitment service device 500 that records the effect of a commitment. A state transition defines how a state machine changes from one state to another state depending on the input(s). In some embodiments, the commitment service device 500 has at least one state machine that includes a combination of logic, memory, and feedback elements.

The commitment can be binding data that is recorded, and attested to, by a party (e.g., the commitment maker device 400). The commitment maker device 400 (or its user) can agree to be bound to the specific value or piece of information committed and cannot change or reverse the commitment without detection. For example, the commitment maker device 400 can be bound to the CID, the cryptographic signature for the commitment maker device 400, and/or other metadata (e.g., timestamp information associated with the creation and/or recording of the commitment record C).

In some embodiments, the commitment record C comprises or contains a content identifier (CID) or other digital fingerprints of one or more digital objects and/or metadata. The CID serves as a identifier for that digital object generated based on the contents of the digital object. For example, a CID for a digital object can be calculated and generated based on one or more cryptographic hash functions of the digital object. As another example, a CID is calculated and generated based on an arrangement and/or sequence of one or more hash functions calculated over one or more components of the digital object. In some embodiments, the CID serves as a unique identifier for that digital object generated based on the contents of the digital object (e.g., the content identifier is a unique content identifier for the digital object so that no two distinct digital objects have a common content identifier). In some embodiments, the commitment record C includes a Merkle tree and/or additional metadata. In some embodiments, the CID is included as part of the Merkle tree or a list of hash values. In some embodiments, the commitment record C is an addition of hashes respectively associated with one or more sets of the one or more digital objects 300. In some implementations, CIDs can be derived using a variety of methods and processes to generate a unique identifier for a digital object.

For example, a CID may be generated by combining unique information about the digital object producer device 100 (e.g., content creator) and the contents (e.g., device ID, network address, and sequence numbers). A sequence number can be the number of the commitments being made by the digital object producer device 100 concatenated with the contents of a digital object.

Sequence numbers can also be part of generating a hash value for digital objects. A hash function can take the content of the digital object along with its sequence number to produce a unique hash value. The addition of a sequence number ensures that even if two objects have identical content, their hash values will differ because of the unique sequence numbers. In the context of hashing, using sequence numbers can ensure uniqueness and help avoid collisions (where two different objects produce the same hash value), because the input to the hash function (e.g., the object content plus the sequence number) is more likely to be unique.

As another example, a CID may be generated based on fingerprinting techniques that can create identifiers based on patterns and statistical properties of the content. As another example, a CID may be generated based on specialized and context-dependent algorithms that can generate an identifier based on specific features within the content itself without relying on a standard hashing algorithm. As another example, digital watermarking can embed unique identifiers into the content, serving as a way to identify the watermarked content later.

In some embodiments, commitments are made related to the structure and organization of digital objects 300, including sets, collections, and labels. Such structural commitments may contain digital objects as well as other structural elements and may involve recursion. For example, a commitment may contain a CID of a digital object [cid(object)], a name of a set of data parameters (e.g., set name), either as a string [set_name] or a CID [cid(set_name)], and information on the object and set membership (e.g., [member(set1, object1), member(set1, [set2, object1])]. As another example, a commitment string C=[cid(set_name), cid(object)] can encode information about a digital object and its membership in a set. In some embodiment, the commitment string CS includes object identifiers {obj1, obj2, . . . } and set identifiers {set1, set2, . . . }. In such embodiments, the commitment service device 500 can verify statements about objects and set existence, timestamps, and membership.

In some embodiments, the commitment service device 500 can verify that a collection of objects or sets provided constitutes a complete set for a given set. For example, the digital object producer device 100 (or commitment maker device 400) can provide a dataset generated by factory temperature sensors that record temperature data structured in the form of sets associated with a time of day, location, user, etc. Temperature sensor readings at various observation times may be required to evaluate manufacturing processes, manage equipment, or perform predictive modeling. If incentives, cost recovery calculations, or other forms of economic compensation are derived from such sensor readings, these readings may be financially sensitive and may be targets for manipulation. For example, by altering a record or by altering the time a record is supposed to have been made, a contractor providing manufacturing services may be able to increase its payments.

The commitment service device 500 can verify that the dataset corresponding to the temperature sensors is a complete set based on a stored commitment associated with that dataset that can include a CID indicative of the source of the data (e.g., hash value of “temperature_sensor1: 62.0,” hash(hash(temperature_sensor1: 62.0)), CID(temperature_sensor1: 62.0), etc.), a CID of the set name (e.g., hash value of “locationl,” hash(hash(locationl)), etc.), a CID of a sum of CIDs of the sources of the data (e.g., CID[CID(temperature_sensor1: 62.0)+CID(temperature_sensor2: 63.1)+CID(temperature_sensor3: 64.9)+ . . . ], etc.), a CID of a public key indicative of an identity of the digital object producer (e.g., CID(public_key(FactoryABC)), etc.) for the data, a CID of timestamps associated with each data record (e.g., a time for recording each temperature sensor reading in a database, a time at which each temperature sensor observed the corresponding temperature and timestamped a time of observation in an internal storage memory for the sensor, etc.), a CID of a combination of data associated with a user identity and a user secret, and/or a CID of other metadata and/or labels associated with each sensor and/or each set.

The commitment maker device 400 may be a stand-alone entity or a system performing operations initiated by another entity, including but not limited to a device, a user, or a service, either directly or via intermediaries. The commitment maker device 400 may initiate actions due to the actions of the digital object producer device 100.

In some embodiments, the commitment maker device 400 monitors for notifications from digital objects producer device 100 that a digital object has been created or modified. In some embodiments, the commitment maker device 400 monitors for notifications from the system storing digital objects 300 that a digital object has been created or modified. In some embodiments, the commitment maker device 400 subscribes to and receives notification on file or other digital object changes from the operating system storing the digital objects. In some embodiments, the commitment maker device 400 subscribes to and receives notification on file or other digital object changes from the web services, cloud infrastructure, network storage systems, or other digital infrastructure storing, maintaining, or managing the digital objects.

In some embodiments, the commitment maker device 400 receives one or more digital objects related to the commitments or the information pertaining to these digital objects and the commitments from the digital object producer device 100. In some embodiments, the commitment maker device 400 receives the digital object related to the commitments or the information pertaining to this digital object and the commitment via the communication layer 200. For example, the digital object producer device 100 may grant the commitment maker device 400 access to the digital object or the ability to query the information pertaining to this digital object. In some embodiments, the commitment maker may access digital objects directly, for instance, on a local file system or via additional services and intermediaries, for instance, cloud services and APIs, such as bucket storage and database services.

In some embodiments, the digital object producer device 100 or the commitment maker device 400 creates a commitment request (CR) comprising the commitment string (CS) and/or additional information, such as an identifier corresponding to an identity of the digital object producer device 100 or an identifier corresponding to an identity of the commitment maker device 400, respectively. In some embodiments, the commitment request (CR) comprises the identifier for the digital object producer device 100 that can be derived from a public key corresponding to a private key of the digital object producer device 100. In some other embodiments, the commitment request (CR) comprises the identifier for the commitment maker device 400 based on a public key respectively corresponding to a private key of the commitment maker device 400. The commitment request (CR) can comprise a combination of identifiers (e.g., private keys based on public keys, user secrets, a combination of device identifier(s) and user secrets, etc.) corresponding to an identity of an entity associated with the digital data.

In some embodiments, the commitment request CR can contain data that encodes the commitment operation to be performed to process the commitment request and the input to the operation (e.g., “data”: encode_data(function_name=“addObject”, args=[object_cid])).

In some embodiments, the commitment request CR can encode a digital object and its membership in a set (e.g., “data”: encode_data(function_name=“addSetObject”, args=[set_cid, object_cid]).

In some embodiments, the commitment request CR is cryptographically signed by the digital object producer device 100 using a private key to create the signed commitment request SCR. The cryptographic signature of the digital object producer device 100 can be generated using the private key associated with the digital object producer device 100.

In some embodiments, to preserve the privacy of data being committed, the commitment request CR includes one or more additional random values combined with the data derived from the object. For example, to preserve the privacy of an object “object1” with low entropy (randomness), the commitment maker can commit CR=cid([object1, noise]) or CR=cid([cid(object1), noise]). In some embodiments, to preserve privacy and allow finer control over information disclosure, the commitment maker device 400 encrypts the object, its derivative, its CID, CID pre-image (e.g, content that produces the corresponding CID), or one or more CIDs or CID pre-images of its components. In some embodiments, more than one commitment maker device 400 may each create one or more commitments related to a single digital object. For example, if the digital object encodes a commercial transaction among parties, each party to the transaction may cause the commitment maker device 400 to create a commitment for that party. In this example, the commitment string CS contains one or more digital objects related to the commercial transaction, and each commitment maker device 400 can sign the commitment record C using its respective private key PKi, creating a signed commitment record SCRi=[CR, sign(PKi, CR)].

In some implementations, the signing is performed by or on behalf of multiple parties. For example, the system can receive from at least two devices distinct and separate from the digital object producer device 100, signature information based on keys (e.g., private keys) respectively associated with each of the at least two devices. The signed commitment request can then be generated based in part on the received signature information based on keys respectively associated with each of the at least two devices. For example, the received signature information is used as the private key (PK).

In some embodiments, multi-party computation (MPC), a cryptographic protocol that allows multiple parties to jointly compute a function over their inputs while keeping those inputs private, is used to create a single signature from multiple parties without revealing their respective private keys. In some embodiments, threshold cryptography, a cryptographic method that allows a group of participants to control a cryptographic key jointly, is used to generate a signature. In some embodiments, the received joint cryptographic key is used as the private key (PK) used for generating the signed commitment record.

Various other methods can be used for multiple parties to sign a commitment jointly, including but not limited to Shamir's secret sharing, ring signatures, Schnorr signatures, other joint signature schemes, and zero-knowledge proofs. Knowledge can refer to the possession of certain information by a party (e.g., the prover device 700) that can be convincingly demonstrated to another party (e.g., the verifier device 800).

In some embodiments, a document can be signed by multiple parties without a need to pass the document among the multiple parties. For example, if a signed commitment record is created for a document using a commitment service device 500 implemented using a smart contract, the smart contract automatically generates a blockchain log entry for the event that is the signing of the commitment record. In some embodiments, the blockchain log entry has a commitment value C that is a CID of the document (e.g., cid(document)) that has been signed. In some embodiments, the blockchain log entry has other useful values, such as identification information of the party signing the document. Each party can add a record of a respective signed commitment record in the form of [C, Sign(C, PKi)]. Other parties to the transaction can query the blockchain event database (e.g., index database or log database) to see signatures by other parties based on stored signature values (e.g., [CID(S), Sign(CID(C),PKi)]) and can verify the corresponding commitments by querying the blockchain state. A blockchain state provides a snapshot of data stored within the blockchain system. In some embodiments, querying the current state of the blockchain provides more secure and reliable verification of the signed commitment records than querying the blockchain event database.

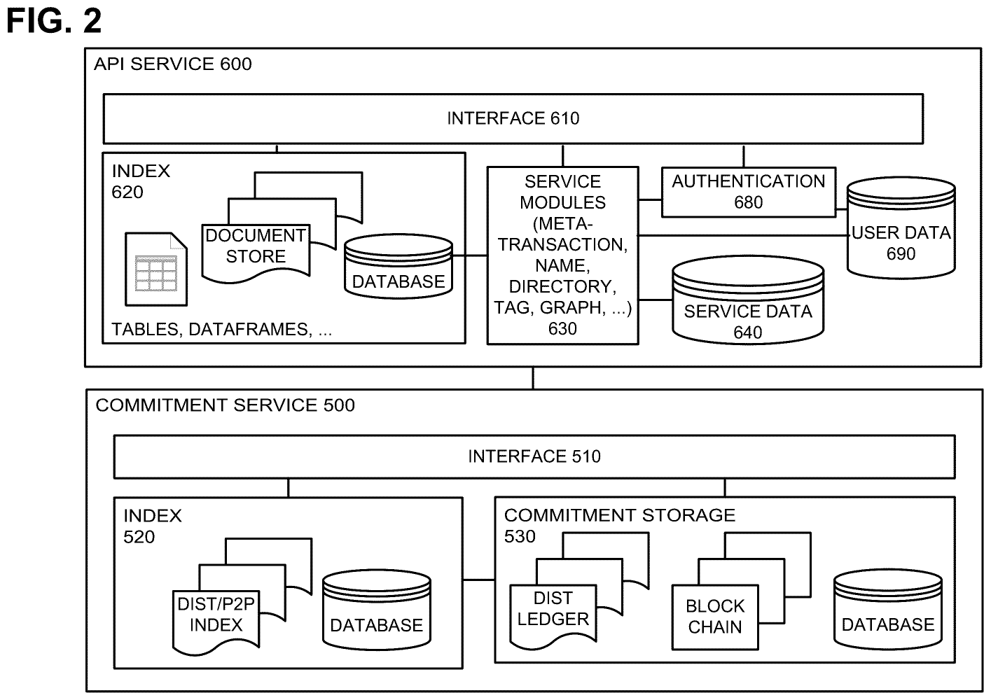

The above multi-party signature schemes may be implemented at/by users 10, commitment maker device 400, API service device 600, and commitment service device 500 as described below and as shown in FIG. 2 below.

FIG. 2 shows an example embodiment of the API service device 600 and the commitment service device 500. The API service device 600 can include an API interface 610 that is communicatively coupled with an API index 620, API service modules 630, an authentication module 680, service data database 640, and user data database 690. The commitment service device 500 can include a commitment service interface 510, a commitment service index 520, and a commitment storage 530.

The API service device 600 can be accessed via the API interface 610. The interface 610 provides entry points for various types of computer programs, networks, and systems that can interact with the commitment service. For example, the interface 610 can provide web service access, HTTP URLs, network ports, and software libraries for accessing the API service device 600. Requests to the interface 610 to interact with the API service are received by the interface, converted into the internal operations of the service, and routed to the internal components of the commitment service 600 discussed below.

The interface 610 can allow authenticated access to the API service device 600. In such cases, an authentication module 680 can be used. The authentication module 680 receives requests from the interface 610 to process requests from users, performs user authentication using user data in user data database 690, and manages user access. The authentication module 680, along with the user data database 690, can provide user quote support and commercial access management.

In some embodiments, the API service device 600 can comprise one or more API service modules 630 providing various high-level operations (e.g., handling meta-transactions, directory maps, data labels, graphical information, etc.). For example, the API service interface 610 and API service modules 630 can provide interfaces for the multiple parties to access any internal functionality necessary to implement joint signatures for the multi-party signature schemes described above.

In some implementations, the service modules 630 includes a module that supports meta-transactions and relaying operations on behalf of the callers of the interface 610. In some implementations, the service modules 630 contains a name service module that converts addresses and other numeric identifiers of creators, users, and signers to names, possibly using user data database 690 (e.g., personal information of users, user devices, etc.) and an additional service data database 640 to store name service data. In some implementations, the service modules 630 include a tag module that enables the tagging of digital objects, commitments, transactions, names, and other identifiers or metadata using names and descriptive strings, using the associated service data in service data database 640. In some implementations, the service modules 630 include a graph module that manages a graph database or relationship among digital objects, commitments, transactions, names, and other identifiers or metadata. For example, a signer with the identity verified using the user data database 690 can sign one or more messages or make one or more transactions to attest to the authenticity of one or more digital objects 300, a signer, a commitment, or any other entry in the user data database 690 and service data database 640.

The authentication module 680 can include algorithms and/or various mathematical functions for providing cryptographic authentication protocols based on binding commitments, set commitments, meta-transactions, public keys, private keys, etc. The service data database 640 can include data and/or programming pertaining to various other functionalities required of the API service device 600. In some embodiments, the API index 620 can include files, documents, and/or digital data stored across various types of databases (e.g., distributed databases, ledgers, specialized databases, append-only databases, etc.).

The commitment service interface 510 and commitment storage 530 can provide interfaces and internal functionality necessary to implement multi-party signatures. In some embodiments, multi-party signatures are submitted to a smart contract executing on a blockchain implementing some or all of the commitment storage 530 functions and verified by the smart contract.

In some embodiments, the commitment maker device 400 uses the API service device 600 to facilitate some or all of the above operations. For example, the commitment maker device 400 can use the API service device 600 to generate a commitment string S for a given digital object or set of digital objects. In some embodiments, the commitment maker device 400 provides digital objects to the API service device 600 or grants the API service device 600 access to the digital objects 300. The API service can access digital objects via a network in order to calculate the commitment string S.

The commitment service device 500 provides storage of commitments. The service receives and verifies commitments. The service ensures that a commitment, its properties, and any statements related to the commitment are verified if and only if they are consistent with the commitment and its properties. The commitment service device 500 can append additional metadata to the commitment C, for instance, it can save the timestamp when the service received the commitment. The timestamp can comprise a sequence of characters or a number encoding the time of an event, for example, date and time within a given time zone.

The commitment service device 500 is accessed via the commitment service interface 510. The interface 510 provides entry points for various types of computer programs, networks, and systems that can interact with the commitment service. For example, the interface 510 can provide web service access, HTTP URLs, network ports, and software libraries for accessing the commitment service device 500. Requests to the interface 510 to interact with the commitment service are received by the interface, converted into the internal operations of the service, and routed to the internal components of the commitment service device 500 discussed below.

The storage for the commitment service can be provided by a commitment storage 530. The commitment storage 530 can be implemented using any infrastructure that supports storage and binding of values necessary to implement credible commitments. Depending on the design requirements, business objections, and infrastructure options, services with varying levels of security guarantees can be used to provide the commitment storage 530. In some embodiments, the commitment service can be provided by a database configured to prevent deletion and changes of commitment records by unauthorized users.

In some embodiments, the commitment service is provided by specialized databases (e.g., an append-only database) where records cannot be altered, removed, or overwritten. An append-only database is a type of database that combines a database with an append-only journal, a ledger, or another secure method of recording changes to the database. An entity controlling the storage of an append-only database must be trusted by participants reliant on that entity's services. Services based on the append-only database can record transactions in milliseconds because a system using the append-only database does not need to communicate with other systems implementing distributed databases, does not need to establish a consensus across multiple systems, and can provide more accurate timestamp determination for recording of digital data.

In some embodiments, the commitment service is provided by a distributed ledger, such as a blockchain, a node in a blockchain peer-to-peer network, or a smart contract running on a blockchain. In some embodiments, the peer-to-peer network comes to a consensus on the timestamp for a transaction that records the commitment string CS, its contents, or some data derived from it, and appends metadata, such as the consensus timestamp for record. In some embodiments, a conventional database service configured with the proper security safeguards is used. Communicating across thousands of nodes on a distributed database takes time and such blockchains operate in relatively long (e.g., 0.1 seconds to minutes) discrete time intervals over which consensus on data and/or respective timestamps is established. Distributed databases provide higher security as compared to append-only databases because they are robust against compromises and failures but have increased overhead costs and greater delay in timestamp generation and determination. For example, the time taken for the distributed network to agree on a time for each new record can be greater than that for append-only databases.

In some embodiments, to improve the reliability, availability, and security of the commitments, storage is provided by several blockchains. For example, a commitment, or data necessary to verify a commitment, can be embedded in a Bitcoin blockchain transaction, stored as a value in an Ethereum smart contract, or inserted into an immutable database. In such embodiments, the commitment storage 530 routes commitment operations to multiple underlying blockchains. In some embodiments, one or more conventional databases configured with the proper security safeguards are used.

In some embodiments, to provide high-performance storage with high-precision timestamps, a specialized database is used to implement some or all of the commitment storage 530 with the required performance characteristics. Such a high-performance database and timestamping can be used in addition to other options, such as a blockchain that provides higher security but lower performance and a lower precision of timestamps.

In some embodiments, the commitment service device 500 uses one or more computers, or nodes, to process or batch commitments, and record resulting batches to one or more high-security distributed ledgers or blockchains. In some embodiments, the commitment storage 530 is provided by a combination of one or more distributed ledger and blockchains to record summary data for collections of commitments and peer-to-peer (P2P) storage systems to store complete commitment data and to facilitate scalable and economic storage and decentralized access to the commitment data.

In some embodiments, to facilitate efficient validation of digital objects, the commitment service device 500 provides commitment indexing and search via the index 520. For example, all commitments can be recorded and stored using data structures and services that facilitate efficient searches. In some embodiments, the recording of CS emits events that are captured by the indexing infrastructure, processed, and stored. Efficient queries for all commitments with various attributes can be subsequently run.

The optional index 520 can use peer-to-peer (P2P) indexing solutions and P2P file systems to facilitate decentralized access to the critical indexing infrastructure that does not suffer from a single point of failure. Such indexing providers offer robustness.

In some implementations, the index 520 is managed by any of the entities participating in the system. For example, if the commitment service device 500 emits events during the processing of a commitment string CS, the verifier device 800 can monitor for these events and maintain the corresponding index 520. As with other components of the system, the communication layer can be facilitating communication within a single computer system or within a single process, and the commitment service device 500, as well as other services and their components, can be part of one or more systems and processes hosting the digital object producer device 100, the commitment maker device 400, the prover device 700, and the verifier device 800.

To enable high-performance queries, the optional index 520 can also use centralized high-performance databases to store copies of the index. Applications that require efficient searches of the index can use such solutions, if available, as an optimization.

To facilitate commitments by parties that are not able to pay for blockchain transactions using cryptocurrency, the commitment service device 500 can support meta-transactions and relaying. In some embodiments, the commitment service records a commitment for commitment maker M1 using a blockchain transaction initiated by and paid for by another party R1.

The commitment service device 500 can have a complex internal architecture to provide high performance. In some embodiments, it can comprise an underlying blockchain BC and a roll-up R operating at a higher throughput and with fewer peer-to-peer nodes. R can periodically post its state and transactions to BC such that all transactions on R can be ultimately verified using BC. In some embodiments, the commitment service can be a side chain S that runs a peer-to-peer network independently of BC, makes its data available independently of BC, and periodically saves a snapshot of its state on BC. In some embodiments, the commitment service device 500 is, or includes, a high-performance cloud server CS that batches transactions into blocks {BL1, BL2, . . . , BLn}, posts a CID or a collection of CIDs for the block on BC, and saves {BL1, BL2, . . . , BLn} using a distributed file storage service such as IPFS. In some embodiments, the commitment service device 500 comprises multiple instances of the above running in parallel, with users or commitments being load-balanced across different instances or shards of the commitment service. In some embodiments, the commitment service provides additional components to ensure the availability of such past blocks, for instance, pinning IPFS content comprising past blocks.

The commitment service device 500 can provide low-level operations only. In some embodiments, a service implemented using a blockchain only supports the writing and reading of values into blockchain storage. An optional API service device 600 can be used to provide commitment, proof, and validation functionality using low-level blockchain features in order to provide higher-order abstractions and complex operations. The API service can also manage infrastructure costs and payments for blockchain transactions. In some embodiments, the API service accepts authenticated calls from users, passes their signed transactions, or initiates transactions on their behalf and pay the blockchain transaction fees for the users.

In some embodiments, the commitment service device 500 or the API service device 600 provide batching of commitments to improve performance and reduce costs. In some embodiments, the API service device 600 receives commitments via the interface 610, collects commitments over a given time window internally using modules that provide API service modules functionality 630, and submits them in a single transaction to the commitment service device 500, or submits a summary of the commitments, such as a Merkle root of a Merkle tree of the commitments. The API service device 600 can record the commitments within the transaction internally or using external storage solutions. In some embodiments, the API service device 600 records batches of transactions using a peer-to-peer storage network, such as IPFS or blockchain data availability solutions. In some instances, when there are delays in the transmission of batches, the batches can be stored prior to transmission, and the batches can be sent via multiple transports and links to one or more commitment services.

In some embodiments, the API service device 600 saves summary information for commitments, digital objects, and other data it has processed in an optional index 620. This index can be maintained to optimize queries for past commitments matching various criteria. In some embodiments, the index is maintained using data structures and databases internal to the API service, such as an SQL or document database. In some embodiments, the index is stored in a peer-to-peer index such as The Graph. The optional index 620 can also use P2P file systems to facilitate decentralized access to the critical indexing infrastructure that does not suffer from a single point of failure. Such indexing providers can offer robustness.

The API service device 600, via the API interface 610, can provide APIs to facilitate an efficient search for commitments matching various filter criteria. For example, the API service device 600 can allow an efficient search for all commitments with a given label, signed by a given public key, or establish a membership in a given set.

In some embodiments, the API service device 600 processes the events that a given commitment string CS emits as it is processed by the commitment service device 500 that are captured by the indexing infrastructure, processed, and stored. Efficient queries for all commitments with various attributes can be subsequently run.

To enable high-performance queries, the optional index 620 can also use centralized high-performance databases to store copies of the index. Applications that require efficient searches of the index can use such solutions, if available, as an optimization.

A prover device 700 makes a statement x that can be evaluated as True or False by external parties. The statement x can contain data, reference digital objects 300, and commitments managed by the commitment service device 500. In some embodiments, the statement x refers to properties of a commitment request CR, signed commitment request SCR, or its contents CS. For example, x can refer to a function of the commitment string CS.

In some embodiments, x asserts that a given digital object DO1 and its properties correspond to an existing commitment C1. For example, x can assert the provenance of DO1 by stating that C1 contains cid(DO1) or timestamp(DO1) is greater than timestamp(C1). In various implementations, different algorithms for calculating the CID of DO1 can be used. For example, if DO1 can be a complex internal structure, the component objects can themselves be represented as CIDs, and cid(DO1) can be calculated as a function of one or more component CIDs, including but not limited to a Merkle tree, another hash of a collection, or a collection of hashes.

In some embodiments, x can be a zero-knowledge proof, such as a Zero-Knowledge Succinct Non-interactive Argument of Knowledge (ZK-SNARK). In some embodiments, x asserts knowledge of a CID pre-image corresponding to some existing commitment C1. In some embodiments, x proves that, given a function F, there is a secret (witness) w such that F(w)=true. In some embodiments, x can prove that, given a function F and input a, there is a secret (witness) w such that F(a, w)=true. Depending on the function F, such proofs can establish any function of digital objects 300 and their commitments recorded with the commitment service device 500.

In some embodiments, the prover device 700 uses the API service device 600 to prepare a proof efficiently. For example, the API service can calculate a proving key for the prover for a given ZK proof.

Once a statement x is generated, it is typically communicated to parties that wish to verify it using the communication layer 200. In some embodiments, the statement x, the proof of x, or access to the interactive communication necessary to validate x, are referenced by an identifier, number, or link. In some embodiments, the prover device 700 produces and shares a Web link that can be used to initiate the validation of x. Validation of x can be interactive, requiring repeated exchanges of information over the communication layer 200 or non-interactive. In some embodiments, where validation of x is interactive, the prover device 700 provides a service, or the API service device 600 provides a service that carries out the interaction necessary to verify x.

A verifier device 800 evaluates statement x. Validation either succeeds or fails depending on the state of the commitment service device 500.

In some embodiments, the verifier device 800 may not require interaction with an external prover device 700 to define x and initiate its verification. For example, a consumer of data can be presented with a collection of digital objects 300. The consumer wishes to verify the provenance and integrity of this collection. The verification of provenance requires verifying that the contents and the metadata of these digital objects have corresponding commitments. The consumer is the verifier device 800 in this case. The consumer can also define the statement x on its own, also acting as the prover device 700. If verifying the provenance of some digital object (e.g., obj1), the consumer verifies that there exists a commitment string CS containing, for example, cid(obj1) and with a timestamp before timestamp(obj1) as reported by the obj1 metadata. In another example, the consumer can be interacting with an interface that includes a list of one or more digital objects and automatically acts as the prover device 700 to formulate statements related to the digital objects and the verifier device 800 to verify the formulated statements. Such statements can include the timestamps of their creation, the signatures or authentication information of the creators, and other object data and metadata, such as provenance information. In some implementations, the statement is verified using one or more of the API service device 600 and the commitment service device 500.

In some embodiments, the verifier device 800 has one or more interactions with one or more of the prover device 700, the API service device 600, and the commitment service device 500 over the communication layer 200 to verify a given statement x. For example, the prover device 700 can provide the verifier device 800 with a link to a Web resource that can be used by the verifier device to verify the statement x.

In some embodiments, the verifier device 800 verifies the provenance and integrity of a collection of data. For example, the digital objects 300 can comprise a folder containing a set of files, a cloud service storage bucket containing a set of objects, or a database table containing a set of records. The verifier device 800 seeks to establish the completeness of the objects and their respective integrity by verifying a set commitment for a set comprising corresponding objects. In the above examples, the set represents the file folder, the cloud service storage bucket, and the database table, and the objects represent the files, the objects, and the records, respectively. The verifier device 800 verifies that there exists a set commitment for some set Set1={Obj1, Obj2, . . . } with the appropriate metadata, such as the set commitment timestamp, and that there exist objects commitments for objects Obj1, Obj2, . . . with the appropriate metadata, such as the object commitment timestamps.

In various embodiments, the verifier device 800 evaluates statements containing one or more functions of the committed objects. For example, the verifier device 800 can evaluate whether a presented object Obj1′ corresponds to some object Obj1 with a known commitment and the result of transforming Obj1 to Obj1′=F(Obj1). In an example where Obj1 is a digital image Img1, the verifier device 800 can evaluate whether Img1 was taken prior to a given timestamp t1, as established by the presence of the commitment C1=cid(Img1), and whether some derivative image Img1′ is a conformant transformation, such as cropping, F(Img1). Jointly, [Verify(C1,t1) AND Img1′=F(Img1)] establish that Img1′ is a derivative of Img1 taken prior to t1.

In some embodiments, the verifier device 800 can verify a zero-knowledge proof and can need access to the associated data. In such cases, the verifier device 800 can need to manage one or more verifier keys and circuits needed to verify proofs.

In some embodiments, the verifier device 800 can need a series of interactions with one or more of the prover device 700, the API service device 600, and the commitment service device 500 over the communication layer 200 to verify a given statement x comprising one or more zero-knowledge proofs. Depending on the implementation, x can contain interactive or non-interactive proofs, zero-knowledge proofs, including but not limited to zk-SNARKs and Zero Knowledge Scalable Transparent Arguments of Knowledge (zk-STARKs).

In some embodiments, the verifier device 800 can use the API service device 600 to manage data, circuits, keys, and verification related to zk-proofs. For example, The API service device 600 can contain a registry of verifier keys that can be used by a prover device 700 to generate proofs for a given verifier device 800 without prior interaction with the verifier device 800.

In some embodiments, the system enables verification of dataset accuracy and completeness. As described above, a commitment request CR can be cryptographically signed by the commitment maker device 400 using a private key to create the signed commitment request SCR. The cryptographic signature of the commitment maker device 400 can be generated using the private key of the commitment maker device 400. For example, a digital object producer device 100 (e.g., Factory_ABC) with a private key (PK) (e.g., PK_ABC) can create a dataset DS1 including a list of records [Rec1, Rec2, . . . ]. After generating the dataset record DS1, the digital object producer device 100 or commitment maker device 400 can create corresponding commitment strings (e.g., CS1=[CID(DS1),CID(Rec1)], CS2=[CID(DS2),CID(Rec2)], . . . CID(DSn),CID(Recn), . . . etc.) that commit the dataset record using APIs (e.g., API service device 600).

For each record (e.g, Rec1, Rec2, . . . Recn, etc.), the digital object producer device 100 or commitment maker device 400 can send to the API service device 600 a signed commitment request SCR=[CS, Sign(CS, PK)]. The API service device 600 can be accessed using various common authentication methods used for SaaS solutions including username and password, multi-factor authentication, single sign-on, OAuth, OpenID, and API Keys). The signed commitment request SCR can be forwarded to a service using an authenticated session. For example, the signed commitment request for the first digital record Rec can be SCR1=[CS1, Sign(CS1, PK_ABC)] and sent by the producer of the first digital record to the API service device 600. The signed commitment requests can establish that each dataset and each record in the respective dataset is known to the entity making the commitment. For example, the signed commitment request including CID(DS1) and CID(Rec1) establishes that DS1 is known by Factory_ABC and that Rec is a member of DS1 is known by Factory_ABC.

In some embodiments, the digital object producer device 100 or commitment maker device 400 can authenticate to the API service device 600 using an API key authentication method to access an HTTP (web) API endpoint provided by the service. The API key method relies on the digital object producer's or commitment maker's knowledge of a secret string of characters that identifies the digital object producer device 100 or commitment maker device 400 and includes secret information to authenticate the digital object producer device 100 or commitment maker device 400.

As described above with respect to FIG. 2, the API service device 600 can be accessed using the API interface 610. In some embodiments, the API interface is an HTTP API endpoint. In some embodiments, the API service device 600 can authenticate the commitment maker device 400 using the authentication module 680 and the corresponding stored user data database 690. For example, the authentication module 680 can search the user data database 690 for the user matching the API key and verify the secret portion of the API key.

In some embodiments, the API service device 600 processes validated and authenticated requests using the meta-transaction module 630. The meta-transaction module 630 can forward the signed commitment request (SCR), signed by the commitment maker device 400, to the commitment service device 500 embedded in a meta-transaction MSCR. For example, the commitment service device 500 can be implemented as a smart contract running on a blockchain, and the API service device 600 uses a meta-transaction to relay a signed commitment request SCR to the blockchain inside the meta-transaction MSCR. The meta-transaction module 630 can embed the signed commitment request SCR in the meta-transaction MSCR for processing by its respective blockchain database based on signing the signed commitment record SCR with a respective key that uniquely corresponds to the API service device 600. The commitment service device 500 can process the meta-transaction MSCR to extract the signed commitment record SCR from it and authenticate the signed commitment request SCR based on verifying the commitment maker's cryptographic signature. The commitment service device 500 then processes the authenticated commitment request CR. In some embodiments, the commitment service device 500 then records the CR on the blockchain, records derivative data of CR on the blockchain, or passes CR to a smart contract function for processing, resulting in change in the state of the blockchain. In some embodiments, the meta-transaction module 630 of the API service device 600 pays the transaction fees (e.g., in cryptocurrency, dollars, etc.) associated with the processing of the meta-transaction MSCR by the commitment service device 500. The API service device 600 can pay the transaction fees on behalf of the commitment maker device or third-parties associated with initiating the commitment.

A smart contract can use a variety of data structures to record set and object commitment. For example, a smart contract can use a mapping data structure to map user identities and CIDs to variables (flags) that are set if a given CID has been committed by the corresponding commitment maker. As another example, a smart contract can use a mapping data structure to store the sum of all CIDs committed for a given set.

In some embodiments, the smart contract implements the commitment service device 500 and generates events corresponding to changes, modifications, and/or creation of digital objects that are logged and indexed in various databases. For example, a searchable database, table, or other index data structure of events emitted with various parameters is maintained by the commitment service index 520 to facilitate verification of commitments.

The events, other records of commitments, and their indices provided by the commitment service index 520 or by the API service index 620 offer simplicity and efficiency gains for system users. Any party can query for past commitments for a given dataset (DS1) or record (Rec1), locate the information for these commitments, and verify them without managing transaction information on its own.

Indexing of commitments and long-term storage and validation provided by blockchains significantly improve on the existing data signing and validation processes that use certificates and private key infrastructure (PKI): API service index 620 and commitment service index 520 remove the need to attach signatures and related metadata to digital objects when they are signed using existing certificate and PKI schemes. Whereas certificate and PKI signing schemes suffer from the long-term validation problem as certificates expire and are replaced or are revoked, blockchains offer secure long-term validation due to their internal implementation as a linked chain of hashes.

In some embodiments, events and the object commitments recorded by the smart contract include the timestamp of the commitment. For example, in a smart contract implemented using Solidity, the timestamp is the time when the peer-to-peer blockchain network implementing the commitment service 530 adds the block containing the commitment transaction to the blockchain.

The timestamp of the commitment can be returned by the commitment service device 500 to the API service device 600 and by the API service to the commitment maker device 400. The timestamp can be recorded in the commitment service index 520 and may be recorded by other modules, such as the API service index 620. This can associate a timestamp with each record (Rec) corresponding to its respective dataset (DS).

In some embodiments, the digital object producer device 100 provides datasets (e.g., DS1) to a consumer (C) for verification. The consumer C can be the verifier device 800. The consumer receives a copy of the dataset and/or is provided with access to read the dataset. The consumer need not receive timestamps, as these can be queried from the API service index 620 or the commitment service index 520. The digital object producer device 100 can provide the data structure of the original records submitted to the API service device 600 and store the observations, and/or records for the digital objects produced.

The consumer (verifier device 800) can verify the completeness of the datasets (e.g., DS1), its records, and their properties. The consumer can use one or both of the commitment service device 500 and the API service device 600 to verify that the datasets match their committed provenance information.

For example, C can verify that there exists a set commitment for DS1 by verifying that there exists a commitment for CID(DS1) as described above, a given user, and a corresponding timestamp for the commitment CID(DS1) and digital object producer device 100 information corresponding to Factory_ABC from the public key information included in the commitment. For example, the commitment can include a hash value of the public key for Factory_ABC that functions as an identifier of Factory_ABC.

As described above, C can verify that the complete set of dataset records were received (e.g., checks set completeness) by calculating the sum of all CID(Rec) for all dataset records. C can then call the smart contract to verify the sum of all recorded objects for a dataset. These steps verify that the list of records is complete and equal to the set of records the commitment maker or digital object producer has committed in the past. In some embodiments, C can use the commitment service interface 510 or the API service interface 610, intermediated by the API service modules 630, to perform the smart contract verification.

In some embodiments, the system enables long-term validation of digital certificates and/or digital signatures. Digital certificates used for creating digital signatures have expiration dates. After a certificate expires, it is no longer valid for generating digital signatures. For long-term validation, there is a need to verify the authenticity of a digital object even after the certificate's expiration. Various complex solutions to the expiration problem may be used, such as creating a chain of timestamps where each timestamp proves that the document existed at a certain point in time. If each timestamp is applied while the previous one is still valid, this chain of timestamps can extend the trustworthiness of a signed digital object into the future. Such a solution is complex and failure-prone, requiring significant engineering and infrastructure investment to achieve reliability. Systems, methods, and devices described herein based on the commitment service device 500 and implemented using a blockchain provide superior long-term validation. For example, the chain of hashes and cryptographic signatures securing each block of the blockchain provide robust long-term validation for all commitments recorded with the commitment service without any additional requirements and any single point of failure.

In some configurations, over the long term, there is an increased risk that private keys used for certificates or digital signatures are compromised. Once a key is compromised, all signatures produced with the key are invalidated. A compromised TSA or CA potentially invalidates all timestamps and signatures that have ever been issued by the affected party since there is no independent means of verifying these. For example, a TSA compromised in January 2020 may be used to issue a signed timestamp for January 2010 that is indistinguishable from a valid timestamp. All historical validation data for a given dataset can be thus invalidated due to a single security failure. Systems, methods, and devices described herein based on the commitment service device 500 implemented using a blockchain do not suffer from this problem. Rewriting block history is practically impossible as it requires compromising the majority of private keys of tens to thousands of independent nodes, maintaining historical block data, and the chain of hashes that links this historical data to the current consensus state of the blockchain. Whereas single-system compromises that access private keys or modify data maintained by a centralized trusted party are common, no such compromises affecting the historical data of the major blockchains have been recorded.

Long-term validation of certificates and TSA-issued timestamps may be impossible if the original data required for validation, such as Certificate Revocation Lists (CRLs) and Online Certificate Status Protocol (OCSP) responses, are not available. Users may need to implement additional services and infrastructure to maintain this data and make it available to verifiers. Studies of certificate revocation rate suggest that 8% of certificates may be revoked (Liu, Yabing; Tome, Will; Zhang, Liang; Choffnes, David; Levin, Dave; Maggs, Bruce; Mislove, Alan; Schulman, Aaron; Wilson, Christo (2015). “An End-to-End Measurement of Certificate Revocation in the Web's PKI”. Proceedings of the 2015 Internet Measurement Conference. Pp. 183-196. Doi:10.1145/2815675.2815685. ISBN 9781450338486. S2CID 1955346.). Such a high failure rate for alternative systems relying on hierarchical trust, PKI, and TSA timestamps makes long-term validation of datasets impractical. Systems, methods, and devices described herein maintain the data necessary for long-term validation as part of the blockchain historical data available on full nodes. Furthermore, thousands of independent nodes need to be compromised to endanger such data.

In some embodiments, a camera worn by law-enforcement personnel is a digital object producer and automatically saves commitments corresponding to captured camera images and/or videos for incidents where such data is generated. In some embodiments, commitments are created when data is generated, periodically downloaded, and/or archived by the system. Commitments for digital objects ensure that the archived media is authentic and has not been modified. When all media for a given body camera is committed using a set corresponding to the body camera, the record of all media created by a given camera can be verified as complete. An incomplete or otherwise altered record of body camera media digital objects produced for verification is detectable since the CIDs of the media digital objects will not match the set commitment recorded in the commitment service for the corresponding set. A set identifier thus makes it possible for the public or others to determine whether a given footage is complete or whether some scenes have been redacted.

In some embodiments, a machine performing quality control on a production process may create a report for each quality examination and save commitments associated with these reports using a set that corresponds to the production process. The object commitments corresponding to the individual examinations and the set commitment corresponding to the production process being monitored can be used by an examiner to determine an accurate production fault rate for the production process. Without a set commitment or an equivalent mechanism of tracking all examinations, it is impossible for an examiner to determine whether they have been presented with all the relevant quality control reports for a given process. For example, if a measurement or a report for the process is withheld, a set commitment allows the examiner to determine that the CIDs for the of the provided reports do not match the set commitment for the production process.

In some instances, bridge inspection records can be challenging and expensive to maintain and authenticate. A dispute related to causation factors associated with a collapsed bridge requires records of past events related to the bridge construction and inspections that are accurate, complete, and verifiable. Methods, systems, and devices described herein provide avenues for authenticating the completeness and accuracy of records through the use of commitment services and set commitments.

In general, various companies (e.g., inspection companies, asset maintenance companies, etc.) can demonstrate to third parties, such as regulators, that digital assets are maintained properly through the use of methods and systems described herein.

In some embodiments, the digital object producer device 100, the commitment maker device 400, and the prover device 700 are the same entity. In some embodiments, the digital object producer device 100 and a prover device 700 are the same entity.

In general, depending on the implementation and the infrastructure environment, the users 10, the digital object producer device 100, the commitment maker device 400, the prover device 700, and a verifier device 800 considered later in the description can operate within a single computer and within a single program. The modular architecture of the system allows these components to be made available within a system or over networks in any combination.

### Example of Verifying Dataset Accuracy and Completeness

A digital object producer device 100 (P) creates a dataset DS1 comprising a list of records DS1=[Rec1, Rec2, . . . ]. Below is a sample record Rec1 consisting of a dictionary (a list of key-value pairs) data structure. The data structure is represented using JavaScript Object Notation (JSON). In this example, the record comprises a list of temperature sensor readings from factory sensors:

```
{
  “SensorA”: 62.0,
  “SensorB”: 63.1,
  “SensorC”: 64.9
}
```

In this example, the digital object producer device 100 (P) is also the commitment maker device 400. After generating each dataset record Rec, P commits the record using APIs provided by the API service 600. For a given record Rec1, P sends to the API service 600 a commitment request CR=[CS, Sign(CS, PK(P))]. CR contains a commitment string CS=[cid(DS1), cid(Rec1)] and a cryptographic signature Sign(CS, PK(P)). Here cid(DS1) is the content identifier (CID) of the dataset DS1, cid(Rec1) is the CID of the record Rec1, and PK(P) is the cryptographic private key of the producer used in the cryptographic signature Signo. In some implementations, cid( ) is a cryptographic hash function over one or more strings. The resulting commitment request CR contains the commitment signed by producer P and establishes the following:
cid(DS1) establishes that DS1 is known to the signer.
cid(Rec1) establishes that Rec is known to the signer, and that Rec is a member of DS1.
The signature Sign(CR, PK(P)) authenticates P, establishing that P is making the commitment and knows the above DS1 and Rec1.

Below is a sample commitment CS=[cid(DS1), cid(Rec1)] for the above sample record Rec1:
[
   “0x0ef773db15419bf83e14a32d762c43871344b360012a10328a2d27ca6013c720”,
   “0xe72bde0169e92451e064f8f91797d8d09c0fba0a1b9aa852c67d97620c5a59d9”
]

In some configurations, the content identifier cid(DS1) is calculated as the Keccak256 hash of the dataset name:
“0x0ef773db15419bf83el4a32d762c43871344b360012a10328a2d27ca6013c720”

In some configurations, the content identifier cid(Rec1) is calculated as the Keccak256 hash of the record represented using the JSON notation:
“0xe72bde0169e92451e064f8f91797d8d09c0fba0alb9aa852c67d97620c5a59d9”

The signed commitment request (SCR), including the identity of the digital object producer and signer derived from the public key, is as follows:

```
{
  “from”: “0x91A1000B65E42a618926703A581A9a545b3bA8Eb”,
  “nonce”:13,
  “data”:
“0x6eb3e17aba162bafdb733c7451e69adf268e6964b0d522d43703d6c13aff4ba0a57c4
2af5aba37668c06324ab0ef87dd932b984a0203cba61d0ea9d5898567f77bfb5a74”
  “signature”:
“0xcfef1a806ccfbd18ed58031652b552e4b465b2e63156d5bf988ecd78e1e2192f08c0d
a9b0f3fbcc96567745c2b1554a40136e24380c60934be1960f757e1b1811c”
}
```

In the example, P authenticates to the API service 600 using an API key authentication method to access an HTTP (web) API endpoint provided by the service. The API key method relies on the user's knowledge of a secret string of characters that identifies the user and includes secret information to authenticate the user.

Below is a sample HTTP request sent by the commitment maker 400 to the HTTP API provided by an API service 600. The request authenticates the commitment maker and sends the commitment request CR to be forwarded to the commitment service 500. The request uses the “x-api-key” HTTP header to authenticate to the API server, identifies the producer P as the “from” field, contains an encoded commitment message request CR in the “data” field, and the producer's signature Sign(CR, PK(P)) in the “signature” field. The additional “nonce” field provides security by ensuring that the signature is valid solely for a given message. The signed commitment request CR is processed only once. Processing fails if CR is re-submitted after successful processing:

```
{
  “id”:43,
  “method”: “POST”,
  “url”: “/forwarder/execute”,
  “query”:{“from”:“0x91A1000B65E42a618926703A581A9a545b3bA8Eb”},
  “headers” :{
    “x-api-key”:“p2SHhp0DiGbrOQOm4IIyEFQp-
qQCWH6OZr2PE8JDJh0IfgVkzJZxQMQZTcxAPWwPDurou9lGo”
  },
  “body” :{
    “from”: “0x91A1000B65E42a618926703A581A9a545b3bA8Eb”,
    “nonce”: 13,
    “data”:
“0x6eb3e17aba162bafdb733c7451e69adf268e6964b0d522d43703d6c13aff4ba0a57c4
2af5aba37668c06324ab0ef87dd932b984a0203cba61d0ea9d5898567f77bfb5a74”
    “signature”:
“0xcfef1a806ccfbd18ed58031652b552e4b465b2e63156d5bf988ecd78ele2192f08c0d
a9b0f3fbcc96567745c2b1554a40136e24380c60934be1960f757e1b1811c”
  }
}
```

The API service 600 is accessed using the interface 610. In this example, the interface is an HTTP API endpoint. The API service 600 authenticates the commitment maker device 400 using the authentication module 680 and its stored user database 690. In this API key authentication example, the authentication module 680 searches the user data 690 for the user matching the API key and verifies the secret portion of the API key.

The API service 600 processes validated and authenticated requests using the meta-transaction module 630. The meta-transaction module 630 forwards the signed commitment request (SCR) to the commitment service device 500. In this example, the commitment service is implemented as a smart contract running on a blockchain, and the API service 600 uses a meta-transaction to relay SCR to the blockchain. The meta-transaction module 630 embeds SCR in the transaction that it signs and transmits and for which it pays the transaction fees.

Below is a sample forwarder function signature that is used to relay messages from the producer P via the API service 600 to the commitment service device 500. The forwarded function signature uses the Solidity smart contract programming language. The function authenticates the forwarded request, checks its signature and nonce, and forwards the call to the target commitment function:

```
/**
  * The forwarded request object
  * Contains the source of the request and the data for the forwarded call.
  */
struct ForwardRequest {
    address from;
    uint256 nonce;
    bytes data;
}
/**
  * Executes the forwarded request if valid.
  *
  * req The request to be executed.
  * signature The signature for the request.
  * (success, returndata) The tuple returned by the call.
  */
function execute(
    ForwardRequest calldata req,
    bytes calldata signature
) external returns (bool, bytes memory);
```

The commitment service device 500 is able to interpret such meta-transactions. For example, the smart contract processing the commitment may interpret SCR as a meta-transaction transmitted and paid for by the API service 500 but signed by P according to Ethereum's EIP-712. In this case, the commitment service device 500 interprets the blockchain transaction made by the API service 600 as a commitment made by P. Below is a sample code using the Solidity programming language and standard cryptographic libraries that verifies the cryptographic signature for a given signed commitment request SCR:

```
function verify(
  ForwardRequest calldata req,
  bytes calldata signature
) public view returns (bool) {
  bytes32 hash = _hashTypedDataV4(
    keccak256(
      abi.encode(
        _FORWARD_REQUEST_TYPEHASH,
        req.from,
        req.nonce,
        keccak256(req.data)
      )
    )
  );
  // Verify the nonce and the user signature.
  return
    _nonces [req.from] == req.nonce &&
    req.from.isValidSignatureNow(hash, signature);
}
```

Such meta-transaction allows the commitment maker device 400 to be simple and efficient, as it is not required to interact with the blockchain directly. For example, the commitment maker 400 need not be aware of the blockchain internals, cryptocurrencies, and the need to pay for blockchain transactions. The API service 600 may use one or more different commitment services device 500 implemented as blockchains or databases and may change these commitment services without any need to modify the commitment maker device 400 or the other modules interacting with the commitment service device 500 via the API service 600.

Below are function signatures using the Solidity smart contract programming language that record a commitment for an object belonging to a set. The function addSetObject( ) is the targets of the forwarded SCR in this example and processes the corresponding commitment request CR after the signature validation:

```
/**
  * Records a set commitment for the calling user.
  *
  * Allows P to declare a set and record all sets thus created.
  * Offers a mechanism to eliminate survivorship and selection family of biases.
  * Provides Sybil resistance with proofs of completeness.
  * Set addition is idempotent:
  * If the user has previously added this set, we ignore the duplicate additions.
  *
  * setHash The hash identifying the set.
  * The setHash will typically be a hash of the set name or identifier.
  */
function addSet(bytes32 setHash) external;
/**
  * Record an object commitment for a set record.
  * A set record commitment establishes that a set record with a given hash
  * has existed at a given time for a given set.
  * This object commitment is unsuitable for proving completeness of user sets
  * and records.
  *
  * Emits an event and records the commitment.
  *
  * setHash The hash identifying the set.
  * objectHash The hash identifying the object.
  */
function addSetObject(bytes32 setHash, bytes32 objectHash) external;
```

A smart contract can use a variety of data structures to record set and object commitment. The example uses the mapping data structure to map user identities and CIDs to variables (flags) that are set if a given CID has been committed. It also uses a mapping data structure to store the sum of all CIDs committed for a given set:
/**
   * User sets stored as flags.
   * This mapping enables V to verify whether a given set has been committed.
   * The mapping also allows a user's set addition to be idempotent.
   * Such idempotence makes proofs of completeness robust against multiple set additions
   * and allows simplified handling: P can add a set when adding its record without worrying about duplicates.
   */
mapping(address=>mapping(bytes32=>bool)) public userSetCommitments;
/**
   * The sum of all set hashes for each user.
   * This sum enables V to verify a proof of completeness of P's sets:
   * P can prove to V that a collection of setNames
   * and corresponding setHashes covers all the sets P has ever created.
   * Such proofs of completeness provide Sybil resistance (https://en.wikipedia.org/wiki/Sybil_attack).
   * The constituent setHashes must be maintained externally or can be retrieved from addSet events.
   */
mapping(address=>uint256) public userSetHashSums;
/**
   * Object commitments stored as flags.
   * This mapping can handle both individual commitments and batches.
   * Sparse commitments are stored individually.
   * Commitment batches can be stored as Merkle roots.
   * Theoretically possible but unlikely collisions are fine:
   * If users know multiple object hash preimages that collide,
   * they are still credibly establishing object provenance for the preimages.
   */
mapping(bytes32=>bool) public objectCommitments;
/**
   * The sum of all record hashes for each user set.
   * This sum enables V to verify proofs of completeness of set records.
   * P can prove to V that a given set of records
   * covers all the records ever created for a given set.
   */
mapping(address=>mapping(bytes32=>uint256))
   public userSetObjectHashSums;

The smart contract functions implementing the commitment service 500 emit events that are logged and indexed. A searchable database, table, or other index data structure of events emitted with various parameters is maintained by the commitment service index 520 to facilitate verification of commitments. Below are events emitted by the above functions:
/**
   * Emitted when a user adds a set commitment.
   */
event AddSet(address indexed user, bytes32 indexed setHash);
/**
   * Emitted when a user adds an object commitment for a set.
   */
event AddSetObject(
   address indexed user,
   bytes32 indexed setHash,
   bytes32 indexed objectHash,
   uint256 timestamp
);

The above events and the object commitments recorded by the smart contract include the timestamp of the commitment. In the example smart contract implemented using Solidity, the timestamp is the time when the peer-to-peer blockchain network implementing the commitment service 530 adds the block containing the commitment transaction to the blockchain. The following sample function incorporates the block timestamp into the event and the commitment:

```
/**
  * Worker function to record an object commitment.
  *
  * user The submitter of the commitment.
  * objectHash The hash identifying the object.
  */
function _addUserObject(address user, bytes32 objectHash) private {
    uint256 timestamp = block.timestamp;
    bytes32 commitment = _calculateCommitmentHash(
      user,
      objectHash,
      timestamp
    );
    emit AddObject(user, objectHash, timestamp);
    objectCommitments[commitment] = true;
}
```

The timestamp of the commitment is returned by the commitment service 500 to the API service 600 and by the API service to the commitment maker 400. The timestamp is also recorded in the commitment service index 520 and may be recorded by other modules, such as the API service index 620. This associates a timestamp with each Rec of the dataset.

Below is a sample dataset DS1 consisting of a list data structure of records and a list data structure of timestamps that resulted from successful commitments of the records. The sample uses the JSON notation:

```
{
  “name”: “TemperatureSensorDataset”,
  “records”: [
    {“SensorA”: 62.0, “SensorB”: 63.1, “SensorC”: 64.9},
    {“SensorA”: 62.2, “SensorB”: 63.2, “SensorC”: 64.8},
    {“SensorA”: 62.2, “SensorB”: 63.3, “SensorC”: 64.7},
    {“SensorA”: 62.2, “SensorB”: 63.4, “SensorC”: 64.6}
  ],
  “timestamps”: [
    “2023-12-14 06:47:33+00:00”,
    “2023-12-14 06:48:35+00:00”,
    “2023-12-14 06:49:37+00:00”,
    “2023-12-14 06:50:40+00:00”
  ]
}
```

The producer device P provides the dataset DS1 to a consumer device CD for verification. In this example, the consumer device CD is also the verifier device 800. The consumer is sent a copy of the dataset or is provided with access to read the dataset. Note that CD need not receive timestamps, as these can be queried from the API service index 620 or the commitment service index 520. The producer device P can thus provide just the data structure of the original records submitted to the API service 600 and only needs to store the observations, or records it collects:

```
{
  “name”: “TemperatureSensorDataset”,
  “records”: [
    {“SensorA”: 62.0, “SensorB”: 63.1, “SensorC”: 64.9},
    {“SensorA”: 62.2, “SensorB”: 63.2, “SensorC”: 64.8},
    {“SensorA”: 62.2, “SensorB”: 63.3, “SensorC”: 64.7},
    {“SensorA”: 62.2, “SensorB”: 63.4, “SensorC”: 64.6}
  ]
}
```

The verifier device 800 verifies the completeness of DS1, its records, and their properties. The consumer device CD uses one or both of the commitment service device 500 and the API service 600 to verify that DS1 provided to CD matches its committed provenance information. Consider the above “TemperatureSensorDataset” example dataset. CD verifies that there is a set commitment for DS1. In this example, CD verifies this commitment by verifying that there exists a commitment for cid(DS1) calculated above, a given user, and a given timestamp:
“0x0ef773db15419bf83el4a32d762c43871344b360012a10328a2d27ca6013c720”

For the commitment service implemented as a smart contract written in Solidity, this commitment can be checked by reading the value of the mapping data structure:
userSetCommitments[user][setHash]

In this example, the verifier 800 obtains record timestamps from the commitment service index 520. It thus reconstructs the time series of records:

```
{
  “name”: “TemperatureSensorDataset”,
  “records”: [
    {“SensorA”: 62.0, “SensorB”: 63.1, “SensorC”: 64.9},
    {“SensorA”: 62.2, “SensorB”: 63.2, “SensorC”: 64.8},
    {“SensorA”: 62.2, “SensorB”: 63.3, “SensorC”: 64.7},
    {“SensorA”: 62.2, “SensorB”: 63.4, “SensorC”: 64.6}
  ],
  “timestamps”: [
    “2023-12-14 06:47:33+00:00”,
    “2023-12-14 06:48:35+00:00”,
    “2023-12-14 06:49:37+00:00”,
    “2023-12-14 06:50:40+00:00”
  ]
}
```

CD verifies that the collection of records committed for the set matches the provided dataset records [Rec1, Rec2, . . . ]. CD verifies that the contents of records [Rec1, Rec2, . . . ] match the object commitments. In this example, CD calculates cid(Rec) for each record above. For example, for the following Rec1:
{“SensorA”: 62.0, “SensorB”: 63.1, “SensorC”: 64.9}

CD calculates its cid(Rec1):
“0x0ef773db15419bf83el4a32d762c43871344b360012a10328a2d27ca6013c720”

CD verifies that commitment exists for the above cid(Rec1). This verification is done by calling the following smart contract function written in Solidity:

```
/**
  * Verifies a user's object commitment.
  * Verifies a direct commitment for an object added by _msgSender( ).
  * _msgSender( ) will return the correct origin of the ultimate sender
  * for commitments sent via relays (meta-transactions).
  *
  * user The submitter of the commitment.
  * objectHash The hash identifying the object.
  * timestamp The timestamp of the commitment.
  * ret True if verification succeeded; false otherwise.
  */
function verifyUserObject(
    address user,
    bytes32 objectHash,
    uint256 timestamp
) external view returns (bool) {
    bytes32 commitment = _calculateCommitmentHash(
      user,
      objectHash,
      timestamp
    );
    return objectCommitments[commitment];
}
```

CD can perform these verifications using the commitment service interface 510 by calling the above function or by a call to the API service interface 610 and intermediated by the API services 630. CD can also verify these values using a replicate of the commitment index 520 and commitment store 530 that it can maintain as a participant in the relevant P2P network.

CD verifies that it received the complete set of dataset records (checks set completeness) by calculating the sum of all cid(Rec) of all dataset records. CD then calls the smart contract to verify the sum of all record (object) cid(Rec) values (hashes) for a dataset (set). These steps verify that the list of records is complete and equal to the set of records P has committed in the past. The following Solidity smart contract function implements this check:

```
/**
  * Verifies a collection of objects for a user set.
  * Verifies that the provided sum of object hashes matches the commitment.
  *
  * user The owner of the set.
  *
  * setHash The hash identifying the set.
  * userSetObjectsHashSum Sum of all object hashes for the user set.
  * ret True if verification succeeded; false otherwise.
  */
function verify UserSetObjectsHashSum(
    address user,
    bytes32 setHash,
    uint256 userSetObjectsHashSum
) external view returns (bool) {
    return userSetObjectHashSums[user][setHash] == userSetObjectsHashSum;
}
```

As elsewhere, CD can perform this verification using the commitment service interface 510 or by a call to the API service interface 610, intermediated by the API services 630.

Below is the pseudocode of the operations CD performs to verify all records as well as the completeness of the records. The pseudocode assumes the variable “records” is a list of records, and the variable “timestamps” is a list of the timestamps for successful commitment operations returned by the commitment service 500 or the API service 600:

```
success = True
hash = get_set_hash_for_dataset(dataset_name)
object_hash_sum = 0
for i, record in enumerate(records):
  timestamp = timestamps[i]
  object_hash = get_object_hash_for_record(record)
  object_hash_sum = add(object_hash_sum, object_hash)
  if not verify_user_object(owner, object_hash, timestamp):
    success = False
if not verify_user_set_objects(
  owner, hash, str_object_hash_sum
):
  success = False
```

If the validation succeeds, CD determines a successful validation of the dataset.

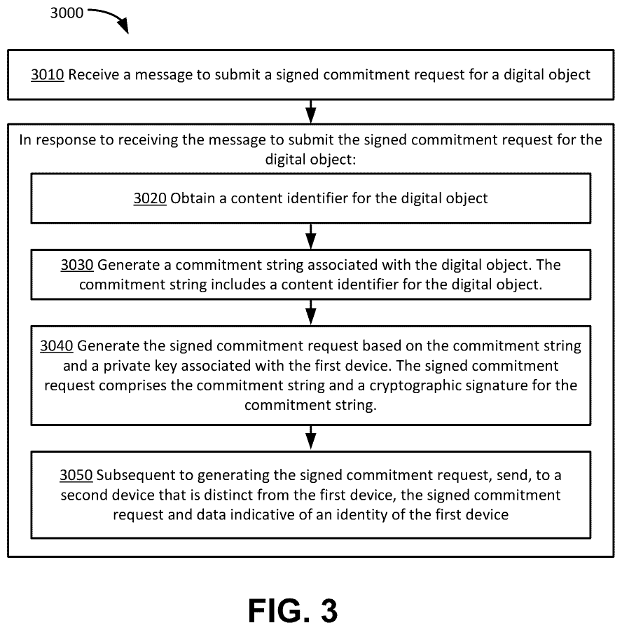

FIG. 3 illustrates a method 3000 for providing authenticatable data in accordance with some embodiments. The method 3000 includes operations performed at a first device with one or more processors and memory storing instructions for execution by the one or more processors (e.g., the method is performed at the first device).

The method 3000 includes receiving (3010) a message to submit a signed commitment request for a digital object; and, in response to receiving the message to submit the signed commitment request for the digital object: obtaining (3020) a content identifier for the digital object; generating (3030) a commitment string associated with the digital object. The commitment string includes a content identifier for the digital object. The method also includes generating (3040) the signed commitment request based on the commitment string and a private key associated with the first device. The signed commitment request comprises the commitment string and a cryptographic signature for the commitment string. The method further includes, subsequent to generating the signed commitment request, sending (3050), to a second device that is distinct from the first device, the signed commitment request and data indicative of an identity of the first device.

In some embodiments, the commitment string further includes at least one of: metadata or set information associated with the digital object.

In some embodiments, the content identifier for the digital object is included as part of a Merkle tree or a list of hash values associated with the digital object.

In some embodiments, the method also includes storing data associated with the commitment string in a database.

In some embodiments, the method also includes determining data associated with the time of recording of the commitment string to the database; and storing data associated with the time of recording of the commitment string to the database in the database.

In some embodiments, the signed commitment request is associated with an event generated during the storing of the data associated with the commitment string in the database, and the event is recorded in a database.

In some embodiments, the method includes determining a time of creation or modification of the digital object; and sending, to a third device for verification of the digital object, (i) a timestamp associated with recording the data associated with the commitment string to the database and (ii) the time of creation or modification of the digital object.

In some embodiments, the database is an append-only database.

In some embodiments, the database is provided by a set of computer nodes on a network (e.g., a P2P commitment service provided by a distributed database).

In some embodiments, the database comprises a ledger.

In some embodiments, the database is a blockchain. In some embodiments, the database is not a blockchain (e.g., a distributed database that is not a blockchain).

In some embodiments, the signed commitment request is associated with an event generated during the storing of the data associated with the commitment string in the database, and the event is recorded in a database. In some embodiments, the database in which the event is recorded is distinct from the database (e.g., a second database) in which the data associated with the commitment string is stored (e.g., a first database).

In some embodiments, the method also includes determining a time of creation or modification of the digital object; and sending, to a third device for verification of the digital object, (i) a timestamp associated with recording the data associated with the commitment string to the database and (ii) the time of creation or modification of the digital object.

In some embodiments, the content identifier is based on a hash value of the digital object.

In some embodiments, the data indicative of the identity of the first device is a key stored on the first device.

In some embodiments, the data indicative of the identity of the first device is based on a public key associated with the first device or a derivative such as a token or a hash value generated using a private key of the first device.

In some embodiments, the public key and the private key associated with the first device form a cryptographic key pair.

In some embodiments, the signed commitment request is generated based in part on cryptographic information associated with the first device and cryptographic information associated with a third device distinct and separate from the first device.

In some embodiments, the method also includes receiving, from a third device distinct and separate from the first device and the second device, signature information based on a key associated with the third device. The signed commitment request is generated based in part on the received signature information based on the key associated with the third device and signature information based on the private key associated with the first device.

In some embodiments, the method further includes, at the second device, generating a forward request based on the signed commitment request, wherein the forward request includes the signed commitment request and data indicative of the identity of the first device; and subsequent to generating the forward request, sending, to a third device, the forward request and data indicative of an identity of the second device.

In some embodiments, the digital object is metadata or set information that may be associated with other digital objects such that the content identifier is a set content identifier

In some embodiments, the method further includes storing data indicative of the identity of the first device and the set content identifier in a database.

In some embodiments, the signed commitment request is associated with an event generated during the storing of the data associated with the commitment string in the database. The event includes data indicative of the identity of the first device and the set content identifier. The event is recorded in a database.

In accordance with some embodiments, an electronic device includes one or more processors; and memory storing one or more programs for execution by the one or more processors. The one or more programs include instructions, which, when executed by the one or more processors, cause the one or more processors to perform any method described herein.

In accordance with some embodiments, a computer readable storage medium stores one or more programs for execution by one or more processors. The one or more programs include instructions for performing any method described herein. In some embodiments, the computer readable storage medium includes a non-transitory computer readable storage medium. In some embodiments, the computer readable storage medium includes a transitory computer readable storage medium.

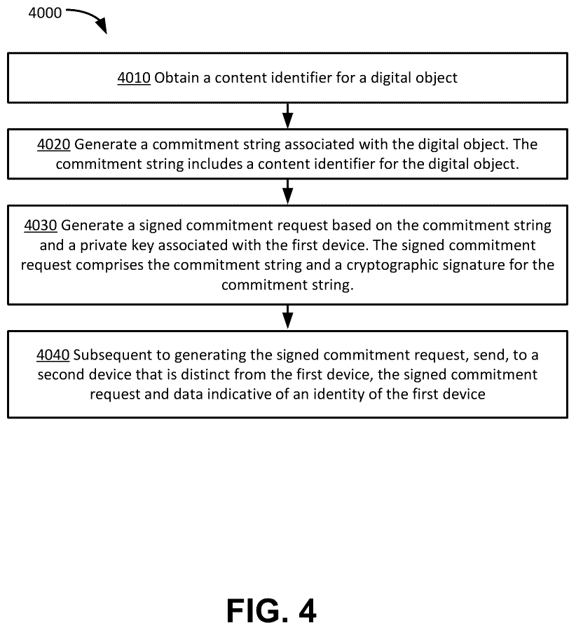

FIG. 4 illustrates a method 4000 for providing authenticatable data in accordance with some embodiments. The method 4000 includes operations performed at a first device with one or more processors and memory storing instructions for execution by the one or more processors (e.g., the method is performed at the first device).

The method 4000 includes obtaining (4010) a content identifier for a digital object; and generating (4020) a commitment string associated with the digital object. The commitment string includes a content identifier for the digital object. The method also includes generating (4030) a signed commitment request based on the commitment string and a private key associated with the first device. The signed commitment request comprises the commitment string and a cryptographic signature for the commitment string. The method further includes, subsequent to generating the signed commitment request, sending (4040), to a second device that is distinct from the first device, the signed commitment request and data indicative of an identity of the first device.

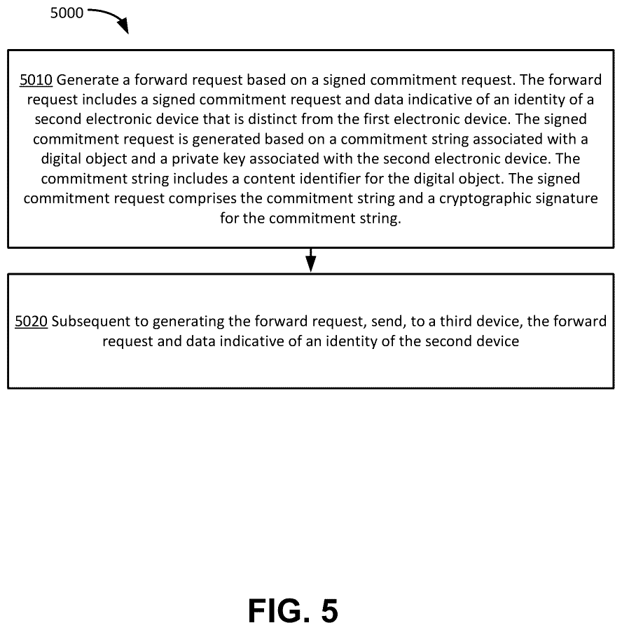

FIG. 5 illustrates a method 5000 for providing authenticatable data in accordance with some embodiments. The method 5000 includes operations performed at a first device (e.g., a forwarder device) with one or more processors and memory storing instructions for execution by the one or more processors (e.g., the method is performed at the first device).

The method 5000 includes generating (5010) a forward request based on a signed commitment request. The forward request includes a signed commitment request and data indicative of an identity of a second electronic device that is distinct from the first electronic device. The signed commitment request is generated based on a commitment string associated with a digital object and a private key associated with the second electronic device. The commitment string includes a content identifier for the digital object. The signed commitment request comprises the commitment string and a cryptographic signature for the commitment string. The method 5000 also includes, subsequent to generating the forward request, sending (5020), to a third device, the forward request and data indicative of an identity of the second device.

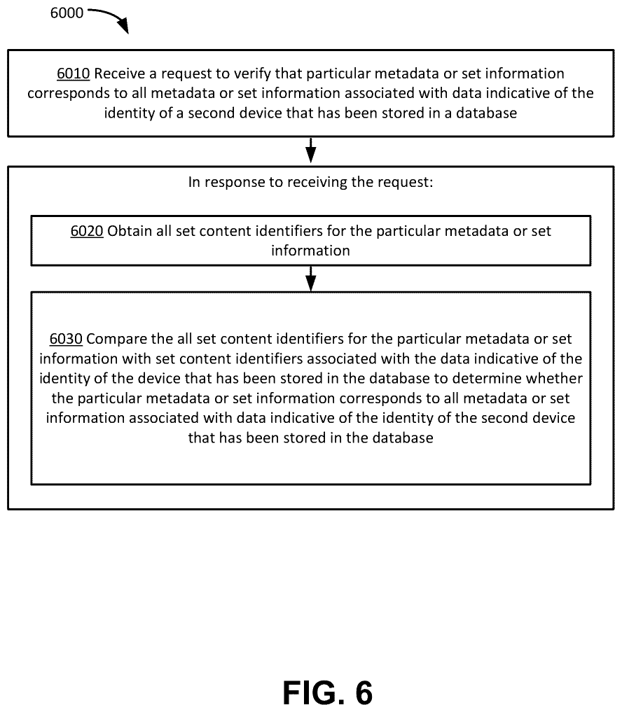

FIG. 6 illustrates a method 6000 for verifying authenticatable data in accordance with some embodiments. The method 6000 includes operations performed at a first device (e.g., a verifier device) with one or more processors and memory storing instructions for execution by the one or more processors.

The method 6000 includes receiving (6010) a request to verify that particular metadata or set information corresponds to all metadata or set information associated with data indicative of the identity of a second device that has been stored in a database. The method 6000 also includes, in response to receiving the request: obtaining (6020) all set content identifiers for the particular metadata or set information; and comparing (6030) the all set content identifiers for the particular metadata or set information with set content identifiers associated with the data indicative of the identity of the device that has been stored in the database to determine whether the particular metadata or set information corresponds to all metadata or set information associated with data indicative of the identity of the second device that has been stored in the database.

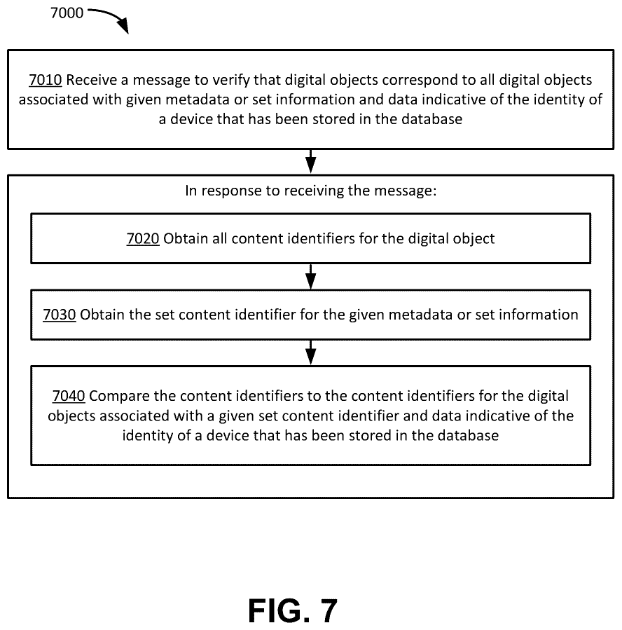

FIG. 7 illustrates a method 7000 for verifying authenticatable data in accordance with some embodiments. The method 7000 includes operations performed at a first device (e.g., a verifier device) with one or more processors and memory storing instructions for execution by the one or more processors.

The method 7000 includes receiving (7010) a message to verify that digital objects correspond to all digital objects associated with given metadata or set information and data indicative of the identity of a device that has been stored in the database. The method 7000 also includes, in response to receiving the message: obtaining (7020) all content identifiers for the digital objects; obtaining (7030) the set content identifier for the given metadata or set information; and comparing (7040) the content identifiers to the content identifiers for the digital objects associated with a given set content identifier and data indicative of the identity of a device that has been stored in the database.

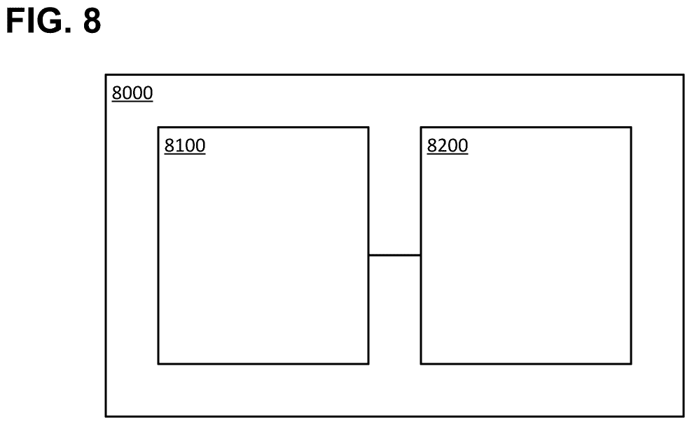

FIG. 8 is a block diagram illustrating an electronic device 8000 in accordance with some embodiments. In some embodiments, any of the first electronic device, the second electronic device, and the third electronic device described herein corresponds to the electronic device 8000 (e.g., the first electronic device has the components of the electronic device 8000, the second electronic device has the components of the electronic device 8000, and the third electronic device has the components of the electronic device 8000). Electronic device 8000 typically includes one or more processing units (CPUs) 8100, one or more network or other communications interfaces, memory 8200, and one or more communication buses for interconnecting these components. In some embodiments, communication buses include circuitry (sometimes called a chipset) that interconnects and controls communications between system components. In some embodiments, electronic device 8000 includes a user interface (not shown) (e.g., a user interface having a display device, a touch screen, a touch pad, a keyboard, and a mouse or other pointing device). In some other embodiments (e.g., when electronic device 8000 is implemented as a server), electronic device 8000 is controlled from and accessed by various client systems.

Memory 8200 of electronic device 8000 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 8200 may optionally include one or more storage devices remotely located from the CPU(s) 8100. Memory 8200, or alternately the non-volatile memory device(s) within memory 8200, comprises a non-transitory computer readable storage medium. In some embodiments, memory 8200 or the computer readable storage medium of memory 8200 stores one or more programs, modules, and data structures, or a subset thereof for performing any method described herein. For example, in some embodiments, the one or more programs include instructions for performing any method described herein.

Some of the embodiments are described based on the following clauses:

Clause 1. A method for providing authenticatable data, the method comprising: at a first device with one or more processors and memory storing instructions for execution by the one or more processors:
receiving a message to submit a signed commitment request for a digital object; and,
in response to receiving the message to submit the signed commitment request for the digital object:
   obtaining a content identifier for the digital object;
   generating a commitment string associated with the digital object, wherein the commitment string includes a content identifier for the digital object;
   generating the signed commitment request based on the commitment string and a private key associated with the first device, wherein the signed commitment request comprises the commitment string and a cryptographic signature for the commitment string; and
   subsequent to generating the signed commitment request, sending, to a second device that is distinct from the first device, the signed commitment request and data indicative of an identity of the first device.
      Clause 2. The method of clause 1, wherein:
the commitment string further includes at least one of: metadata or set information associated with the digital object.
   Clause 3. The method of clause 2, further comprising:
obtaining a set content identifier for the data associated with the metadata or set information associated with the digital object; and
storing the set content identifier, the object content identifier, and data indicative of the identity of the first device in a database.
   Clause 4. The method of clause 3, further comprising:
storing data associated with object content identifiers associated with the set content identifier and the identity of the first device in a database.
   Clause 5. The method of clause 3 or 4, wherein the signed commitment request is associated with an event generated during the storing of the data associated with the commitment string in the database, the event includes the set content identifier associated with the digital object, and the event is recorded in a database.
   Clause 6. The method of any of clauses 1-5, wherein:
the content identifier for the digital object is included as part of a Merkle tree or a list of hash values associated with the digital object.
   Clause 7. The method of any of clauses 1-6, further comprising:
storing data associated with the commitment string in a database.
   Clause 8. The method of clause 7, further comprising:
determining data associated with the time of recording of the commitment string to the database; and
storing data associated with the time of recording of the commitment string to the database in the database.
   Clause 9. The method of clause 8, wherein the signed commitment request is associated with an event generated during the storing of the data associated with the commitment string in the database, and the event is recorded in a database.
   Clause 10. The method of clause 8 or 9, further comprising:
determining a time of creation or modification of the digital object; and
sending, to a third device for verification of the digital object, (i) a timestamp associated with recording the data associated with the commitment string to the database and (ii) the time of creation or modification of the digital object.
   Clause 11. The method of any of clauses 7-10, wherein the database is an append-only database.
   Clause 12. The method of any of clauses 7-11, wherein the database is provided by a set of computer nodes on a network.
   Clause 13. The method of any of clauses 4-12, wherein the database comprises a ledger.
   Clause 14. The method of any of clauses 4-13, wherein the database is a blockchain.
   Clause 15. The method of any of clauses 1-14, wherein the content identifier is based on a hash value of the digital object.
   Clause 16. The method of any of clauses 1-15, wherein the data indicative of the identity of the first device is a key stored on the first device.
   Clause 17. The method of any of clauses 1-16, wherein the data indicative of the identity of the first device is based on a public key associated with the first device or a derivative such as a token or a hash value generated using a private key of the first device.
   Clause 18. The method of clause 17, wherein the public key and the private key associated with the first device form a cryptographic key pair.
   Clause 19. The method of any of clauses 1-18, wherein the signed commitment request is generated based in part on cryptographic information associated with the first device and cryptographic information associated with a third device distinct and separate from the first device.
   Clause 20. The method of any of clauses 1-19, further comprising:
receiving, from a third device distinct and separate from the first device and the second device, signature information based on a key associated with the third device, wherein the signed commitment request is generated based in part on the received signature information based on the key associated with the third device and signature information based on the private key associated with the first device.
   Clause 21. The method of any of clauses 1-20, further comprising:
at the second device, generating a forward request based on the signed commitment request, wherein the forward request includes the signed commitment request and data indicative of the identity of the first device; and
subsequent to generating the forward request, sending, to a third device, the forward request and data indicative of an identity of the second device.
   Clause 22. The method of any of clauses 1-21, wherein:
the digital object is metadata or set information that may be associated with other digital objects such that the content identifier is a set content identifier
   Clause 23. The method of clause 22, further comprising:
storing data indicative of the identity of the first device and the set content identifier in a database.
   Clause 24. The method of clause 23, wherein the signed commitment request is associated with an event generated during the storing of the data associated with the commitment string in the database, the event includes data indicative of the identity of the first device and the set content identifier, and the event is recorded in a database.
   Clause 25. An electronic device comprising one or more processors and memory storing one or more programs for execution by the one or more processors, the one or more programs including instructions for performing the method of any of clauses 1-20.
   Clause 26. A distributed electronic system, comprising a first device and a second device, wherein the first device includes one or more processors and memory storing one or more programs for execution by the one or more processors, the one or more programs including instructions for performing the method of any of clauses 1-20 and the second device includes one or more processors and memory storing one or more programs for execution by the one or more processors, the one or more programs including instructions for performing the method of any of clauses 21-24.
   Clause 27. A non-transitory computer readable storage medium storing one or more programs for execution by one or more processors of an electronic device, the one or more programs including instructions for performing the method of any of clauses 1-20.
   Clause 28. A non-transitory computer readable storage medium storing a first set of one or more programs for execution by one or more processor of a first electronic device and a second set of one or more programs for execution by one or more processors of a second electronic device, the first set of one or more programs including instructions for performing the method of any of clauses 1-20, the second set of one or more programs including instructions for performing the method of any of clauses 21-24.
   Clause 29. A method for providing authenticatable data, the method comprising: at a first electronic device with one or more processors and memory storing instructions for execution by the one or more processors:
generating a forward request based on a signed commitment request, wherein:
   the forward request includes a signed commitment request and data indicative of an identity of a second electronic device that is distinct from the first electronic device;
   the signed commitment request is generated based on a commitment string associated with a digital object and a private key associated with the second electronic device;
   the commitment string includes a content identifier for the digital object; and
   the signed commitment request comprises the commitment string and a cryptographic signature for the commitment string; and
subsequent to generating the forward request, sending, to a third device, the forward request and data indicative of an identity of the second device.
   Clause 30. The method of clause 29, wherein:
the commitment string further includes at least one of: metadata or set information associated with the digital object.
   Clause 31. The method of clause 30, further comprising:
obtaining a set content identifier for the data associated with the metadata or set information associated with the digital object; and
storing the set content identifier, the object content identifier, and data indicative of the identity of the first device in a database.
   Clause 32. The method of clause 31, further comprising:
storing data associated with object content identifiers associated with the set content identifier and the identity of the first device in a database.
   Clause 33. The method of clause 31 or 32, wherein the signed commitment request is associated with an event generated during the storing of the data associated with the commitment string in the database, the event includes the set content identifier associated with the digital object, and the event is recorded in a database.
   Clause 34. The method of any of clauses 29-33, wherein:
the content identifier for the digital object is included as part of a Merkle tree or a list of hash values associated with the digital object.
   Clause 35. The method of any of clauses 29-34, further comprising:
storing data associated with the commitment string in a database.
   Clause 36. The method of clause 35, further comprising:
determining data associated with the time of recording of the commitment string to the database; and
storing data associated with the time of recording of the commitment string to the database in the database.
   Clause 37. The method of clause 36, wherein the signed commitment request is associated with an event generated during the storing of the data associated with the commitment string in the database, and the event is recorded in a database.
   Clause 38. The method of clause 36 or 37, further comprising:
determining a time of creation or modification of the digital object; and
sending, to a third device for verification of the digital object, (i) a timestamp associated with recording the data associated with the commitment string to the database and (ii) the time of creation or modification of the digital object.
   Clause 39. The method of any of clauses 35-38, wherein the database is an append-only database.
   Clause 40. The method of any of clauses 35-39, wherein the database is provided by a set of computer nodes on a network.
   Clause 41. The method of any of clauses 32-40, wherein the database comprises a ledger.
   Clause 42. The method of any of clauses 32-41, wherein the database is a blockchain.
   Clause 43. The method of any of clauses 29-42, wherein the content identifier is based on a hash value of the digital object.
   Clause 44. The method of any of clauses 29-43, wherein the data indicative of the identity of the first device is a key stored on the first device.
   Clause 45. The method of any of clauses 29-44, wherein the data indicative of the identity of the first device is based on a public key associated with the first device or a derivative such as a token or a hash value generated using a private key of the first device.
   Clause 46. The method of clause 45, wherein the public key and the private key associated with the first device form a cryptographic key pair.
   Clause 47. The method of any of clauses 29-46, wherein the signed commitment request is generated based in part on cryptographic information associated with the first device and cryptographic information associated with a third device distinct and separate from the first device.
   Clause 48. An electronic device comprising one or more processors and memory storing one or more programs for execution by the one or more processors, the one or more programs including instructions for performing the method of any of clauses 29-47.
   Clause 49. A non-transitory computer readable storage medium storing one or more programs for execution by one or more processors of an electronic device, the one or more programs including instructions for performing the method of any of clauses 29-47.
   Clause 101. A method for verifying authenticatable data, the method comprising: at a first device with one or more processors and memory storing instructions for execution by the one or more processors:
receiving a request to verify that particular metadata or set information corresponds to all metadata or set information associated with data indicative of the identity of a second device that has been stored in a database; and,
in response to receiving the request:
   obtaining all set content identifiers for the particular metadata or set information; and
   comparing the all set content identifiers for the particular metadata or set information with set content identifiers associated with the data indicative of the identity of the device that has been stored in the database to determine whether the particular metadata or set information corresponds to all metadata or set information associated with data indicative of the identity of the second device that has been stored in the database.
      Clause 102. The method of clause 101, wherein:
the database stores the value of a function calculated, in part, using the set content identifiers associated with the data indicative of the identity of the second device; and
comparing the set content identifiers to the set content identifiers associated with the data indicative of the identity of the device that has been stored in the database involves comparing the values of the function calculated, in part, using the provided content identifiers and the value of the function stored in the database.
   Clause 103. A method for verifying authenticatable data, the method comprising: at a first device with one or more processors and memory storing instructions for execution by the one or more processors:
receiving a message to verify that digital objects correspond to all digital objects associated with given metadata or set information and data indicative of the identity of a device that has been stored in the database; and,
in response to receiving the message:
   obtaining all content identifiers for the digital objects;
   obtaining the set content identifier for the given metadata or set information; and
   comparing the content identifiers to the content identifiers for the digital objects associated with a given set content identifier and data indicative of the identity of a device that has been stored in the database.
      Clause 104. The method of clause 103, wherein:
the message includes data associated with the time of recording of the commitment strings associated with the digital objects in the database or the time of creation of digital objects.
   Clause 105, The method of clause 104, further comprising:
comparing the time of recording of the commitment strings associated with the digital objects in the database or the time of the creation of digital objects to the content identifiers to time of recording of the commitment string to the database stored in the database.
   Clause 106. The method of clause 103, wherein:
the database stores the value of a function calculated, in part, using the content identifiers for the digital objects;
comparing the content identifiers to the content identifiers for the digital objects associated with a given set content identifier and data indicative of the identity of a device involves comparing the values of the function calculated, in part, using the provided content identifiers and the value of the function stored in the database for a given set content identifier and data indicative of the identity of a device.
   Clause 107. The method of any of clauses 101-106, wherein the database is an append-only database.
   Clause 108. The method of any of clauses 101-107, wherein the database comprises a ledger.
   Clause 109. The method of any of clauses 101-108, wherein the database is a blockchain.
   Clause 110. An electronic device comprising one or more processors and memory storing one or more programs for execution by the one or more processors, the one or more programs including instructions for performing the method of any of clauses 101-109.
   Clause 111. A non-transitory computer readable storage medium storing one or more programs for execution by one or more processors of an electronic device, the one or more programs including instructions for performing the method of any of clauses 101-109.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method for providing authenticatable data, the method comprising:
at a first device with one or more processors and memory storing instructions for execution by the one or more processors:
receiving a message to submit a signed commitment request for a digital object; and,
in response to receiving the message to submit the signed commitment request for the digital object:
obtaining a content identifier for the digital object;
generating a commitment string associated with the digital object, wherein the commitment string includes a content identifier for the digital object;
generating the signed commitment request based on the commitment string and a private key associated with the first device, wherein the signed commitment request comprises the commitment string and a cryptographic signature for the commitment string; and
subsequent to generating the signed commitment request, sending, to a second device that is distinct from the first device, the signed commitment request and data indicative of an identity of the first device.

2. The method of claim 1, wherein:
the commitment string further includes at least one of: metadata or set information associated with the digital object.

3. The method of claim 2, further comprising:
obtaining a set content identifier for the data associated with the metadata or set information associated with the digital object; and
storing the set content identifier, the object content identifier, and data indicative of the identity of the first device in a database.

4. The method of claim 3, further comprising:
storing data associated with object content identifiers associated with the set content identifier and the identity of the first device in a database.

5. The method of claim 3, wherein the signed commitment request is associated with an event generated during the storing of the data associated with the commitment string in the database, the event includes the set content identifier associated with the digital object, and the event is recorded in a database.

6. The method of claim 1, wherein:
the content identifier for the digital object is included as part of a Merkle tree or a list of hash values associated with the digital object.

7. The method of claim 1, further comprising:
storing data associated with the commitment string in a database.

8. The method of claim 7, further comprising:
determining data associated with the time of recording of the commitment string to the database; and
storing data associated with the time of recording of the commitment string to the database in the database.

9. The method of claim 8, wherein the signed commitment request is associated with an event generated during the storing of the data associated with the commitment string in the database, and the event is recorded in a database.

10. The method of claim 8, further comprising:
determining a time of creation or modification of the digital object; and
sending, to a third device for verification of the digital object, (i) a timestamp associated with recording the data associated with the commitment string to the database and (ii) the time of creation or modification of the digital object.

11. The method of claim 7, wherein the database is an append-only database.

12. The method of claim 7, wherein the database is provided by a set of computer nodes on a network.

13. The method of claim 4, wherein the database comprises a ledger.

14. The method of claim 4, wherein the database is a blockchain.

15. The method of claim 1, wherein the content identifier is based on a hash value of the digital object.

16. The method of claim 1, wherein the data indicative of the identity of the first device is a key stored on the first device.

17. The method of claim 1, wherein the data indicative of the identity of the first device is based on a public key associated with the first device or a derivative such as a token or a hash value generated using a private key of the first device.

18. The method of claim 17, wherein the public key and the private key associated with the first device form a cryptographic key pair.

19. The method of claim 1, wherein the signed commitment request is generated based in part on cryptographic information associated with the first device and cryptographic information associated with a third device distinct and separate from the first device.

20. The method of claim 1, further comprising:
receiving, from a third device distinct and separate from the first device and the second device, signature information based on a key associated with the third device, wherein the signed commitment request is generated based in part on the received signature information based on the key associated with the third device and signature information based on the private key associated with the first device.

21. The method of claim 1, further comprising:
at the second device, generating a forward request based on the signed commitment request, wherein the forward request includes the signed commitment request and data indicative of the identity of the first device; and
subsequent to generating the forward request, sending, to a third device, the forward request and data indicative of an identity of the second device.

22. The method of claim 1, wherein:
the digital object is metadata or set information associated with other digital objects such that the content identifier is a set content identifier.

23. The method of claim 22, further comprising:
storing data indicative of the identity of the first device and the set content identifier in a database.

24. The method of claim 23, wherein the signed commitment request is associated with an event generated during the storing of the data associated with the commitment string in the database, the event includes data indicative of the identity of the first device and the set content identifier, and the event is recorded in a database.

25. An electronic device comprising one or more processors and memory storing one or more programs for execution by the one or more processors, the one or more programs including instructions for:
receiving a message to submit a signed commitment request for a digital object; and,
in response to receiving the message to submit the signed commitment request for the digital object:
obtaining a content identifier for the digital object;
generating a commitment string associated with the digital object, wherein the commitment string includes a content identifier for the digital object;
generating the signed commitment request based on the commitment string and a private key associated with the first device, wherein the signed commitment request comprises the commitment string and a cryptographic signature for the commitment string; and
subsequent to generating the signed commitment request, sending, to a second device that is distinct from the first device, the signed commitment request and data indicative of an identity of the first device.

26. A non-transitory computer readable storage medium storing one or more programs for execution by one or more processors of an electronic device, the one or more programs including instructions for:
receiving a message to submit a signed commitment request for a digital object; and,
in response to receiving the message to submit the signed commitment request for the digital object:
obtaining a content identifier for the digital object;
generating a commitment string associated with the digital object, wherein the commitment string includes a content identifier for the digital object;
generating the signed commitment request based on the commitment string and a private key associated with the first device, wherein the signed commitment request comprises the commitment string and a cryptographic signature for the commitment string; and
subsequent to generating the signed commitment request, sending, to a second device that is distinct from the first device, the signed commitment request and data indicative of an identity of the first device.

27. A method for providing authenticatable data, the method comprising:
at a first electronic device with one or more processors and memory storing instructions for execution by the one or more processors:
generating a forward request based on a signed commitment request, wherein:
the forward request includes a signed commitment request and data indicative of an identity of a second electronic device that is distinct from the first electronic device;
the signed commitment request is generated based on a commitment string associated with a digital object and a private key associated with the second electronic device;
the commitment string includes a content identifier for the digital object; and
the signed commitment request comprises the commitment string and a cryptographic signature for the commitment string; and
subsequent to generating the forward request, sending, to a third device, the forward request and data indicative of an identity of the second device.
